(19) United States
(12) Patent Application Publication
(10) Pub. No.: US 2024/0417966 A1
(43) Pub. Date: Dec. 19, 2024

(54) WOOD-CONCRETE COMPOSITE SLAB HAVING A PLANAR WOOD ELEMENT, METHOD FOR PRODUCTION OF SAME, AND CONSTRUCTIONS HAVING SUCH A WOOD-CONCRETE COMPOSITE SLAB

(71) Applicants: IMPLENIA SCHWEIZ AG, Opfikon (CH); WALTGALMARINI AG, Zürich (CH)

(72) Inventors: Christian KÜNDIG, Eschenbach (CH); Benjamin KREIS, Zürich (CH); Wolfram KÜBLER, Mettmenstetten (CH)

(21) Appl. No.: 18/702,309

(22) PCT Filed: Oct. 16, 2022
(86) PCT No.: PCT/EP2022/078753

§ 371 Date: Apr. 17, 2024

(30) Foreign Application Priority Data
Oct. 17, 2021 (EP) 21203049.8

(51) Int. Cl. E04B 1/14; B32B 7/08; B32B 13/04; B32B 21/04; B32B 37/15

(52) U.S. Cl. CPC E04B 1/14; B32B 7/08; B32B 13/04; B32B 21/04; B32B 37/15; B32B 2307/102; B32B 2315/06; B32B 2317/16; B32B 2419/00

(57) ABSTRACT

A wood-concrete composite slab having a planar wood element, by means of which spans with little dependence upon the relative inherent weight of the slab are achieved. The slab layer construction includes a wood layer, an insulating layer, and a concrete layer. In one embodiment, the layer construction is interrupted by at least one bearing means, in that this bearing means traverses at least the concrete layer and the insulating layer and extends downward at least as far as the wood layer. In a different embodiment, for a high level of soundproofing, the slab comprises in its insulating layer two different-density insulating materials, wherein the denser insulating material rests directly on the wood layer, acting as a vibration damping means. In a further embodiment, the wooden panels of the wood-concrete composite slab that form the planar wood element are tensioned against one another in order to convey tensile forces therethrough.

The invention relates to a wood-concrete composite slab having a planar wood element. Compared to pure concrete slabs, this slab is characterized by a considerably lower weight. Even compared to conventional wood-concrete composite slabs, the slab according to the invention provides a more lightweight and slender design. In this context, spans can be achieved with this slab system with very little dependence upon the relative inherent weight of the slab (i.e., calculated on the slab area). The invention further relates to a method for producing such slabs, a use, and a building having one or more such wood-concrete composite slabs.

Slabs having large spans are very desirable. Especially in multi-story and many-story buildings, such as high-rise buildings, they offer a gain in space utilization and variable options in the slab plan design of the stories. Moreover, large slab spanned dimensions also create flexibility in subsequent remodeling, because fewer load-bearing walls and columns have to be installed within a story. Achieving large slab spans also using wood-concrete composite slabs would be very desirable in every case.

A large spanned dimension, however, poses the same challenge to any slab planning: in order to be able to apply the required flexural rigidity and load-bearing capacity, the slab requires a sufficient static height. This in turn is reflected in its inherent weight—also in the case of a wood-concrete composite slab. In its conventional embodiment with the concrete on wood, the inherent weight of the slab then increases proportionally to the height. This places corresponding requirements on the vertical support structure and foundation of the building on which the loads have to be supported. In particular in high-rise construction with many stories, this represents a great challenge. Furthermore, a high slab thickness also has a negative effect on utilization, because fewer slabs can then be achieved for a certain height of a building. It would thus be desirable to be able to realize higher spans without the aforementioned disadvantages thanks to special wood-concrete composite slabs.

Although wood-concrete composite slabs with wood beams, i.e., with linear wood components, are already encountered in office and residential buildings, and sometimes also in high-rise buildings, the wood-concrete composite slab construction has not yet resolved all problems in order to be able to become established to the full extent. As the aforementioned slabs are used, viz., interspersed with wood beams, they are satisfying only to a limited degree from an architectural perspective. With the comparatively modest use of wood, merely as an axial grid through the slab, the ecological potential of the building material wood also cannot be sufficiently tapped. Quite apart from its properties as CO₂ storage means, wood involves a comparatively low pollutant emission during processing, and likewise requires low energy consumption for the installation. The larger dimensioning of the wood component in a wood-concrete composite slab would consequently have only a positive effect on the climate impact of a building, which would be very desirable in any case. However, one is confronted here with two problems.

On the one hand, the use of more wood in the composite slab also calls for restrictive fire protection measures for the plan. It is true that static and architectural requirements could be met at the same time in the embodiment of a wood-concrete composite slab having a planar wood element, because such a slab can provide a finished and aesthetically appealing soffit as the bottommost composite layer. However, in this case, supports are in the way, which is why a combustible planar wood element cannot simply be exposed on the interior side—especially not in spaces with large spanned dimensions. The fire protection requirements tend to become more restrictive, the more slabs a building comprises, or the longer the evacuation paths are, wherein, of course, the use of and number of occupants in the building also play a role.

On the other hand, a larger proportion of wood in a wood-concrete composite slab means that it also offers less sound protection. As a substantially lighter composite partner than concrete, wood can much more easily be excited into vibrations. The structure-borne sound can therefore be propagated comparatively easily in a wood-concrete composite slab with a planar wood element and can be perceived by the building users. This prevents the use of such slabs—particularly in apartment buildings, in office buildings, for educational facilities like schools, universities, libraries, etc., and generally wherever high demands are placed on sound protection. In particular, this means that in buildings having separate utilization units, e.g., apartment and office units, room units of educational facilities, etc., which must be acoustically isolated from different parties using the building, the slab must be interrupted at the transition points of the individual units. This has a disadvantageous effect both on the slab statics and on the efficiency of the slab assembly.

The problems explained result in conventional wood-concrete composite slabs with a planar wood element with large spans not being usable: first, because of the proportional increase in inherent weight, secondly, because of the fire protection requirements, and, thirdly, because of the sound propagation. With such slabs, the utility or apartment units of a building ultimately cannot be appropriately spanned, so that comparatively small-span slab elements are still used, which also impairs construction and assembly efficiency.

Numerous constructions including wood and concrete components have become known in the prior art in the past decades. Some of such design suggestions are presented below.

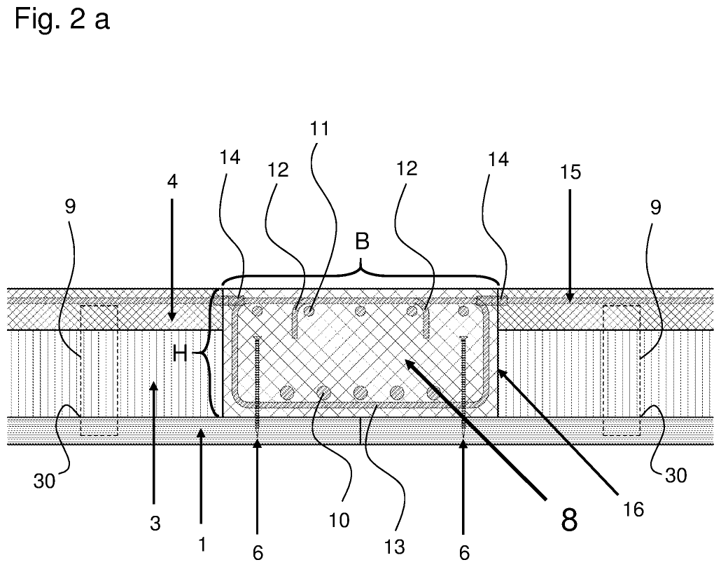

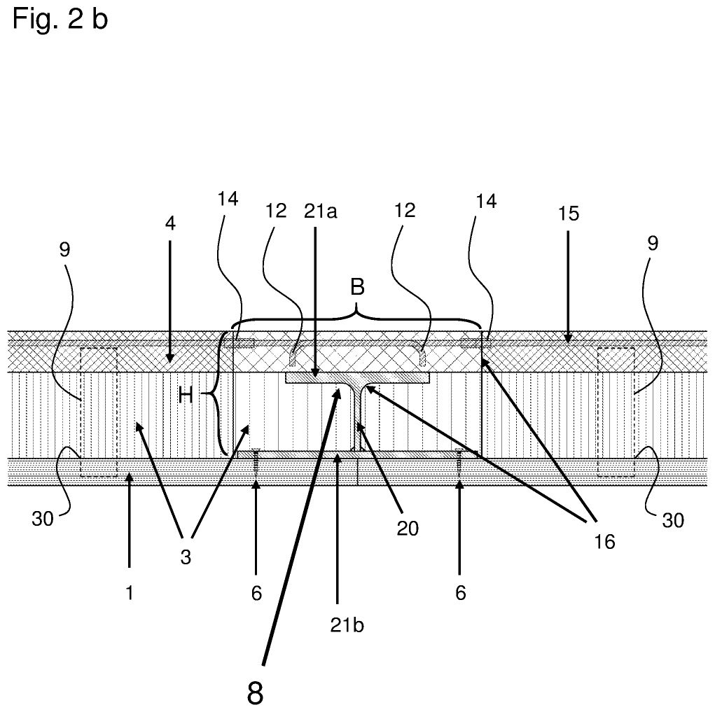

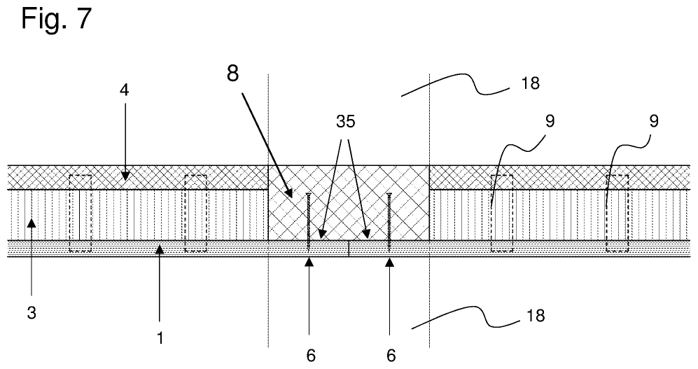

U.S. Pat. No. 2,268,311 A, published in 1941, discloses a slab construction with a support structure made of concrete. The concrete upper slab with its downwardly projecting ribs, which are V-shaped in cross-section, is completely enclosed on its underside. A lower, horizontally running layer made of a plaster coating can be suspended in the finishing stage as follows: according to the embodiment shown in FIG. 2, wood slats (wood furring strips) are suspended, via said slats, on the ribs, which form the side wings as hangers at the bottom, in the longitudinal direction of the ribs. In this case, the tips of the individual wood slats just barely touch one another below the flange. In another variant according to FIG. 7, the slats are pushed along exactly fitting recesses in the longitudinal direction of the ribs via a cambered U-shaped bracket fastened therein, and then the bracket ends thereof are bent laterally. Plaster base panels can be applied to the slats fastened in this way. The connections between the concrete support structure and the plaster base slats are realized only at the locations of the bearing means on which the slats are suspended.

In CH 223 498, published in 1942, a wood-concrete composite construction is presented in which the supporting wood component is designed in the form of wood beams. These wood beams have recesses on their upper side into which the concrete can penetrate from above and fill them. A shear-resistant surface adhesion is realized due to the interlocking of wood and concrete. Filling bodies—so-called Hourdi blocks—are laid between the wood beams and are each supported laterally on a wood beam. Here too, shear connections are realized only at the locations of the bearing means.

Another proposal for a wood-concrete construction is found in EP 0 280 228 A1, published in 1988. The supporting wood component of the slab structure presented therein is in turn designed in the form of beams running parallel to and spaced apart from one another. These form the lower slab closure. Above this, an insulating layer, over which the concrete upper slab comes to rest, is held by a formwork. The latter is connected to the wood beams via steel pipes. For this purpose, recesses are present both in the formwork and in the insulating layer, as a result of which the connecting pipes penetrate downwards into the wood beams. With its upper end portion, the connecting tubes are cast in the concrete of the upper slab. The shear connection is thus realized only at the locations of the bearing means.

DE 10 37 687 B, published in 1958, discloses a reinforced concrete rib or reinforced concrete beam slab. Cast-in-place concrete ribs formed at the bottom are framed in laterally by support rails made of wood, metal, or plastic. These support rails serve as supports for prefabricated concrete slabs. On the other hand, they interact with a plaster base arranged below them, viz., a tubular mesh mat, plate, or a lightweight plate, as permanent formwork for the cast-in-place concrete ribs. The support rails are on the one hand supported on a supporting wall, and on the other on a wooden yoke made of columns and cross-beams. The document does not disclose any shear connectors that engage into the concrete as well as into the support rails or into the wooden yoke.

The document FR 2 143 603 A1, published in 1973, discloses a slab construction which includes a steel beam with a cambered T-profile. Hourdi blocks, which constitute a permanent formwork, are placed on the shoulders of the cambered T-beam. The relatively thick middle layer of the Hourdi blocks is made of a foamed lightweight material (foamed polyurethane, Styropor, or material known under the brand name, Kégecell), covered at the top by an upper insulating layer of greater density (consisting of, for example, asbestos cement panels, gypsum board panels, or the like). Below the foamed lightweight material follows a layer of chipboard panels or the like. The insulating material of the upper Hourdi layer thus has a much greater density than the foamed light material of the thick, middle Hourdi layer, which in turn rests on the chipboard layer. A further layer of the same foamed lightweight material of the thick, middle Hourdi layer is suspended from these Hourdi blocks or nailed from below into the chipboard panels. This is also provided at the bottom with a plasterboard layer as a visual finish layer. Again, no shear connection with shear connectors protruding into the concrete and into the wood is disclosed.

US 2018/0328019 A1 shows a slab-ceiling panel made of a slab panel and a ceiling panel spaced apart therefrom with bearing means installed therebetween in the form of steel profiles having a C-shaped cross-section. The connection between slab and ceiling panels is formed solely by these metal bearing means consisting of aluminum or steel, which are screwed at the top to a metal partition wall layer and at the bottom into a slab layer advantageously consisting of non-combustible material. In the cavities formed between slab and ceiling panels, through which the metal bearing means also extend, an insulating material for thermal or acoustic insulation is placed at a distance from the lower ceiling layer.

Finally, a Brettstapel system is presented in US 2006/179741 A1, published in 2006. The individual Brettstapel elements are stacked on top of one another and are connected with hardwood dowels. For this purpose, holes are drilled into the Brettstapel elements into which the dowels are inserted. Because the moisture content of the dowels during installation is lower than that of the Brettstapel elements consisting of a softwood, a moisture equilibrium is established over time. The hardwood dowels here expand or swell. An isotropic pressure is produced that is directed radially onto the inner walls of the bore holes of the Brettstapel elements. The cohesion of the Brettstapel elements is due to this alone. The individual hardwood dowels preferably pass through the entire Brettstapel. Alternatively, however, a single hardwood dowel can also be designed to be shorter. However, the Brettstapel elements are not tensioned against one another, due to the contact pressure as a result of the dowels. However, the Brettstapel elements can be tensioned according to their length, for which purpose recesses are taken out in their bottommost portion, which recesses form channels when the Brettstapel elements are laid together, for inserting a cable or the like. Such a Brettstapel wood construction system is also suitable for wood-concrete composite slabs, as will be explained later.

In CA 2 176 450 A1, published in 1997, a wood beam consisting of numerous individual wood components stacked together in the transverse direction to the beam is presented. A cable which is tensioned on both sides of the wood beam leads through these wood components. For this purpose, an anchor plate or hollow box is applied to the outermost wood components of the beam, and the cable is finally tensioned thereon by means of a hydraulic press. This type of tensioning is suitable where space is present on both sides of a wood beam—for example, in the case of a boom which is mounted at a distance from its own concrete base.

With the exception of the two last documents mentioned above, all of the aforementioned solutions disclose bearing means (wood, concrete, metal bearing means) or projections from concrete of the concrete upper slabs that are formed to be downwards. It is thereby apparent that connections between the concrete and the wood run through the bearing means or projections of the concrete (regardless of whether the wood component of the corresponding construction assumes a supporting function at all). This leads to substantial weight concentrations of the slab at precisely these locations of the connection of concrete to wood. Such a wood-concrete connection accordingly correlates with the total weight of the slab. In general, it holds that, if wood-concrete connections, such as shear connectors, are arranged in one or more bearing means and/or in channels of the wood component filled with concrete or in projections of the concrete, the construction of a wood-concrete composite slab extending over large spans with substantial wood content and accordingly required strong connection to the concrete upper slab proves to be very challenging, as was explained at the outset with reference to the problem of large slab weight loads.

Against this background, the object of the present invention is to further tap into the energy-efficient construction potential of wood in a wood-concrete composite slab for the buildings mentioned at the outset. In particular, the slab should enable large spans with a low increase in weight. In this way, it should also be possible to use such units to cover spans in a comprehensive manner in terms of spaces and in buildings having separate residential, office, or utility units. Due to the nature of the slab, it should also be possible to close off spaces on the interior side with a layer made of wood, and thus a material which is in principle flammable, lightweight, and conducts sound well, while meeting fire protection and/or sound protection requirements. As a slab soffit, the wood layer is thus made distinctive in terms of interior architecture. The object is furthermore to specify such a wood-concrete composite slab and a method for efficient industrial production thereof, and a sound protection design of the wood-concrete composite slab using insulating material. Moreover, the object of the invention is to specify a building with one or more such wood-concrete composite slabs.

This object is achieved by combinations of features according to the invention, as are expressly defined below in accordance with the sections [0020] to [00120], and with reference to the claims in the section [00121]. Back references with section numbering are to be understood as subsidiary. Critical for the definitions of the invention here is the following: for a device defined with a minimum number of features (wood-concrete composite slab, building), any combinations with parts or all other device features are also disclosed as advantageous embodiments of the device. Similarly, for a method defined with a minimal number of features, any combinations with parts or all further method features are disclosed as advantageous embodiments of the method. Likewise, with all methods, a device (wood-concrete composite slab, building) with its various possible device features can be created or produced and is disclosed in each case as an advantageous embodiment of the method. In addition, the use in a device (wood-concrete composite slab, building) with its various possible device features can be realized and is therefore disclosed as an advantageous embodiment of the use.

The invention relates to a wood-concrete composite slab, the support structure of which comprises a component of concrete and a component of wood which is connected thereto in a shear-resistant manner, wherein the slab comprises a layer construction which, from bottom to top, includes, first, a wood component, viz., a wood layer, extended in a planar manner which can be subjected to a tensile load in the composite of the slab, followed by an insulating layer, and finally a concrete layer, wherein shear connectors are installed in the composite slab, with at least one shear connector simultaneously protruding into the wood layer and into the concrete layer, and thereby passing through the insulating layer, and wherein the layer construction of the slab is interrupted by at least one bearing means in that said bearing means traverses at least the concrete layer and the insulating layer and extends downwards at least as far as the wood layer.

According to one advantageous embodiment, the wood-concrete composite slab according to the invention comprises the combination of the features according to section [0020], wherein the at least one bearing means projects over its length partially or completely out of the composite slab in that is projects downwards and/or upwards out of the same.

According to a further advantageous embodiment, the wood-concrete composite slab according to the invention comprises the combination of the features according to one of sections [0020] or [0021], wherein the projection, which is partially shaped downwards over its length, of the bearing means is designed as a capital of a column adjacent to the bearing means.

According to a further advantageous embodiment, the wood-concrete composite slab according to the invention comprises any combination of features according to one or more of sections [0020] to [0022], wherein the at least one bearing means contains reinforcing steels and/or a steel profile having at least one lower flange as reinforcement.

According to a further advantageous embodiment, the wood-concrete composite slab according to the invention comprises any combination of features according to one or more of sections [0020] to [0023], wherein the one or more bearing means is/are dimensioned in terms of their number such that their weight is up to 10% of the total weight of the slab.

According to a further advantageous embodiment, the wood-concrete composite slab according to the invention comprises any combination of features according to one or more of sections [0020] to [0024], wherein, in the case of an up to 50% extension of the span of the composite slab, up to a total length of 9 m of the extended span, the span-dependent weight increase of the slab does not exceed 10% of the slab weight, and the slab thickness varies by only 5-10 cm, in order to ensure greater flexibility in the slab plan design.

The invention also relates to a method for producing a wood-concrete composite slab having any combination of features according to one or more of sections [0020] to [0025], with at least two slab modules,
a. wherein the slab modules are each created with their layer construction, so that, from the bottom up, first, the wood layer with the shear connectors anchored therein with its lower ends is produced, then the insulating layer is formed, and finally the concrete layer is applied with its reinforcement, so that the upper ends of the shear connectors are anchored in the concrete layer,
b. the slab modules are laid in the position predetermined for them on one or more supports, wherein either
i. the two slab modules abut and thereby form an intermediate space which is delimited below by a contact surface, excluded provisionally from material application, on the wood layer of at least one of the slab modules and is delimited on the side by its insulating and concrete layers,
or
ii. at least one of the supports is a prefabricated bearing member which forms a lower projection which forms a step on both sides, on which steps in each case a slab module is then supported on the bearing member, wherein, between the concrete layers of the slab modules supported in this manner, an intermediate space is left above the bearing member,
c. a bearing means reinforcement is inserted into the intermediate space and connected to the adjacent concrete reinforcement, and
d. the intermediate space is filled with concrete and, with curing thereof, the bearing means is completely created.

According to an advantageous embodiment, the method comprises the combination of the features according to section [0026], wherein, for each slab module,
a0. first of all, the wood layer is processed in that the shear connectors are introduced into the same and fastened therein, wherein a formwork encloses the wood layer for the construction of the further layers, and the formwork delimits any contact surface on the wood layer,
a1. the insulating layer is formed over the wood layer within the formwork,
a2. then, over the insulating layer, the reinforcement for the concrete layer is inserted within the formwork, and
a3. the concrete layer is poured within the formwork and, after said layer has cured, the formwork is removed, whereby the slab module is created.

According to a further advantageous embodiment, the method comprises the combination of features according to one of sections [0026] or [0027], wherein, for a bearing means projecting at the top,
d0. a concrete formwork connecting at the top and extending at the top is applied to the intermediate space,
d1. the correspondingly delimited space is filled with concrete, and
d2. the concrete formwork is removed again after the concrete has cured, whereby the bearing means at the top is completely created.

The invention further relates to a wood-concrete composite slab the support structure of which comprises a component of concrete and a component of wood which is connected thereto in a shear-resistant manner, wherein the slab comprises a layer construction which, from bottom to top, includes, first, a planar wood component, viz., a wood layer, which can be subjected to a tensile load in the composite of the slab, followed by an insulating layer, and finally a concrete layer, wherein shear connectors are installed in the composite slab, of which at least one shear connector simultaneously extends into the wood layer and into the concrete layer and in doing so passes through the insulating layer, wherein the insulating layer comprises at least two insulating materials of different densities or specific weights, and the denser insulating material is arranged directly on this wood layer in the slab composite and can be subjected to a tensile load or rests directly thereon, which increases the inertia of the wood layer and is intended to act as a vibration damping means.

According to an advantageous embodiment, the wood-concrete composite slab according to the invention comprises the combination of the features according to section [0029], wherein the layer construction of the slab either extends without bearing means over the slab, or at least one bearing means traverses at least the concrete layer and the insulating layer, and consequently extends downwards at least as far as the wood layer.

According to a further advantageous embodiment, the wood-concrete composite slab according to the invention comprises the combination of the features according to one of sections [0029] or [0030], wherein an upper layer of less dense insulating material rests on a lower layer of denser insulating material.

According to a further advantageous embodiment, the wood-concrete composite slab according to the invention comprises any combination of features according to one or more of sections [0029] to [0031], wherein a cavity is formed in the slab so that the less dense insulating material consists of air, wherein the concrete layer rests on a permanent concrete formwork above the cavity.

According to a further advantageous embodiment, the wood-concrete composite slab according to the invention comprises any combination of features according to one or more of sections [0029] to [0032], wherein air is excluded as a material for the less dense insulating material, or the slab is free of cavities made up of air.

According to a further advantageous embodiment, the wood-concrete composite slab according to the invention comprises any combination of features according to one or more of sections [0029] to [0033], wherein the difference in the densities or specific weights of the insulating materials is 0.5 to 2 t/m³.

According to a further advantageous embodiment, the wood-concrete composite slab according to the invention comprises any combination of features according to one or more of sections [0029] to [0034], wherein the contact pressure of the denser insulating material is between 0.7 and 1.4 kN per m², and the contact pressure of the less dense insulating material is between 0.1 and 0.4 kN per m².

According to a further advantageous embodiment, the wood-concrete composite slab according to the invention comprises any combination of features according to one or more of sections [0029] to [0035], wherein the denser insulating material consists of a concrete granulate made of crushed concrete or of a mixed granulate of crushed concrete and masonry, and the less dense insulating material consists of lightweight building material.

Furthermore, the invention relates to a use of at least two insulating materials of different densities or specific weights as sound protection by means of vibration damping of the wood layer in a wood-concrete composite slab according to any combination of features according to one or more of sections [0020] to [0036], or a use of at least two insulating materials of different densities or specific weights in direction-dependent arrangement or direction-dependent sequence as sound protection by means of vibration damping of the wood layer in a wood-concrete composite slab according to any combination of features according to one or more of sections [0020] to [0036].

In addition, the invention relates to a method for producing a wood-concrete composite slab according to any combination of features according to one or more of sections [0029] to [0036] with at least two slab modules,
a. wherein the slab modules are each created with their layer construction, so that, from bottom to top, the wood layer is produced with the shear connectors anchored therein with their lower ends,
b. the insulating layer is then formed with at least two insulating materials in that, first, the denser insulating material is introduced, which increases the inertia of the wood layer and is intended to act as a vibration damping means, and then the less dense insulating material is arranged or a cavity is left open for this purpose,
c. finally, the concrete layer is created with its reinforcement so that the upper ends of the shear connectors are anchored in the concrete layer, wherein, for connection to the at least second slab module, the reinforcement thereof protrudes from the concrete layer in recesses thereof, and
d. the completely created slab module is laid in the position predetermined for it on one or more supports and is connected to the at least second slab module in that the reinforcements of the adjacent concrete layers are frictionally connected, and the recesses are then concreted.

According to an advantageous embodiment, the method comprises the combination of the features according to section [0038], wherein, for each slab module,
a0. first, the wood layer is processed in that the shear connectors are introduced into the same and fastened therein, wherein a formwork encloses the wood layer for the construction of the further layers,
c0. after creating the insulating layer, the reinforcement for the concrete layer is inserted within the formwork over said insulating layer, and
c1. the concrete layer is poured within the formwork and, after the same has cured, the formwork is removed, whereby the slab module is created.

The invention further relates to a wood-concrete composite slab, the support structure of which comprises a component of concrete and a component of wood which is connected thereto in a shear-resistant manner, wherein the slab comprises a layer construction which, from bottom to top, includes, first, a planar wood component, viz., a wood layer, which can be subjected to a tensile load in the composite of the slab, followed by either an insulating layer and finally a concrete layer, or, in the absence of the insulating layer, is followed or directly followed by a concrete layer, wherein the wood layer includes at least two abutting wooden panels, which are reciprocally tensioned against one another, in that the one wooden panel presses perpendicularly against the other wooden panel at a parting plane formed when they abut, wherein, in each of the wooden panels tensioned against one another in this way while leaving intact their underside, at least one recess is created by material removal in such a way that the at least one box-shaped space is formed in the wooden panel and with a recess of the wooden panel located on the remote side of the parting plane forms a recessed passage that spans across the two wooden panels, wherein the wooden panels, as viewed from the parting plane, are left intact in a space extending behind their one or rear box-shaped space in a direction perpendicularly away from the parting plane and therefore form there a rear intact material for other use, wherein the tensioning means are introduced in the passage and anchored at each end in at least one box-shaped space, so that the wooden panels are tensioned against one another as a result of the tensioning means being tightened.

According to an advantageous embodiment, the wood-concrete composite slab according to the invention comprises the combination of the features according to section [0040], wherein the layer construction of the slab either extends without bearing means over the slab, or at least one bearing means traverses at least the concrete layer and the insulating layer when an insulating layer is present, and as a result extends downwards at least as far as the wood layer.

According to an advantageous embodiment, the wood-concrete composite slab according to the invention comprises the combination of features according to section [0040] or [0041], wherein the region which is left intact adjoins directly behind the one or rear box-shaped space and extends in a direction perpendicularly away from the parting plane.

According to a further advantageous embodiment, the wood-concrete composite slab according to the invention comprises any combination of features according to one or more of sections [0040] to [0042], wherein the region which is left intact extends either as far as one end of the wooden panel which is opposite the end, located at the parting plane, of the wooden panel, or the region extends as far as a box-shaped space of the same wooden panel arranged for tensioning with a further wooden panel.

According to a further advantageous embodiment, the wood-concrete composite slab according to the invention comprises any combination of features according to one or more of sections [0040] to [0043], wherein the tensioning means bears against a location, upstream of the parting plane, within the wooden panel.

According to a further advantageous embodiment, the wood-concrete composite slab according to the invention comprises any combination of features according to one or more of sections [0040] to [0044], wherein the tensioning means does not bear directly against a parting plane or an end face of the wooden panel.

According to a further advantageous embodiment, the wood-concrete composite slab according to the invention comprises any combination of features according to one or more of sections [0040] to [0045], wherein the at least one box-shaped space is designed to be open towards the top or open towards the top and at the end.

According to a further advantageous embodiment, the wood-concrete composite slab according to the invention comprises any combination of features according to one or more of sections [0040] to [0046], wherein the at least one box-shaped space for accommodating an anchoring of the tensioning means is rectangular.

According to a further advantageous embodiment, the wood-concrete composite slab according to the invention comprises any combination of features according to one or more of sections [0040] to [0047], wherein either
i. a tensioning means is loosely inserted into the passage and tensioned by abutting with pressure against a spared/remaining/untouched front—as seen from the parting plane—intact material of the wooden panel and, in the case of a hollow channel running therein, is not intact solely for this reason, or, in the case of a hollow channel running therein for the tensioning means acting orthogonally to the parting plane, is not intact solely for this reason, so that the abutting wooden panels are reciprocally tensioned against one another perpendicular to the parting plane, and/or
ii. the tensioning means is anchored in at least one or, as viewed from the parting plane, rear box-shaped space such that at least one end face of the rear intact material remains free of anchoring means.

According to a further advantageous embodiment, the wood-concrete composite slab according to the invention comprises any combination of features according to one or more of sections [0040] to [0048], wherein the passage spanning across the two wooden panels is removed symmetrically with respect to the parting plane, so that the recesses of the wooden panels can be produced identically and/or the tensioning means can be used independently of the side, and/or the tensioning means can be used independently of the side, so as to act orthogonally to the parting plane.

According to a further advantageous embodiment, the wood-concrete composite slab according to the invention comprises any combination of features according to one or more of sections [0040] to [0049], wherein the tensioning means components form an arrangement symmetrical to the parting plane, and/or the tensioning means components are laid so as to act orthogonally to the parting plane.

According to a further advantageous embodiment, the wood-concrete composite slab according to the invention comprises any combination of features according to one or more of sections [0040] to [0050], wherein the tensioning means is realized
i. as a threaded connection with screw heads anchored at the end, or
ii. as a lever-actuated tensioning lock with tensioning blocks, anchored at the end, gripped by a tensioning arm, or
iii. as a wedge connection, wherein, for the wedge connection, the front intact material—which, in the case of a hollow channel running therein, is not intact solely for this reason, or which, in the case of a hollow channel for the tensioning means running therein that act orthogonally to the parting plane, is not intact solely for this reason—on the two wooden panels in each case reaches as far as the parting plane, and a tensioning wedge and a counter-wedge within a box-shaped space of a near-side wooden panel, as viewed from the parting plane, are arranged behind the front intact material, and a threaded rod with the counter-wedge and with a tensioning block is anchored in the opposite box-shaped space of the remote-side wooden panel, so that, when the tensioning wedge is knocked down or knocked in or clamped, the front intact material located between the tensioning block, and the tensioned wedges acting as tensioning block is subjected to pressure.

According to a further advantageous embodiment, the wood-concrete composite slab according to the invention comprises any combination of features according to one or more of sections [0040] to [0051], wherein the recesses each form—as viewed from the parting plane—a rear chamber and a front chamber which are connected via a hollow channel in the front intact material, as a result of which said front intact material is not intact solely due to the hollow channel, or as a result of which said front intact material is not intact solely due to the hollow channel for the tensioning means acting orthogonally to the parting plane, wherein the tensioning means is anchored in each end in the rear chamber by means of screw heads or tensioning blocks, and the front chamber of a near-side wooden panel in each case forms a common chamber open at the top with the front chamber of the wooden panel located on the remote side of the abutment axis, wherein a continuous threaded connection is realized via the hollow channels and the common chamber, which thread connection can be tensioned in the common chamber either by fixed-location rotation of a sleeve, by a coupling including a central nut and two threaded pipe sections which can be pulled together by said nut, or by a nipple.

Furthermore, the invention relates to a method for producing a wood-concrete composite slab according to any combination of features according to one or more of sections [0040] to [0052], in that,
a. in the wooden panels to be tensioned, the at least one recess is each created, by material removal, in such a way that it forms at least one box-shaped space,
b. the wooden panels are then laid in abutment, wherein their recesses form a recessed passage spanning across the two wooden panels, and
c. the tensioning means is introduced into the passage and on the end is anchored in each case in the at least one or rear box-shaped space,
d. and the tensioning means is tensioned from above.

According to an advantageous embodiment, the method comprises the combination of features according to section [0053] in that
i. the tensioning means is inserted loosely into the passage and is anchored in such a way that, when subjected to tensile stress at a spared/remaining/untouched front intact material, which, in the case of a hollow channel running therein, is not intact solely for this reason, or which, in the case of a hollow channel running therein for the tensioning means acting orthogonally to the parting plane, is not intact solely for this reason, bears with pressure against said tensioning means, so that the abutting wooden panels are reciprocally tensioned against one another perpendicular to the parting plane, and/or
ii. the tensioning means is anchored in the at least one or rear box-shaped space such that at least one end face of the rear intact material remains free of anchoring means.

According to a further advantageous embodiment, the method comprises the features according to one of sections [0053] or [0054], wherein
a. the recesses each form a rear chamber and a front chamber, which are connected via a hollow channel in the front intact material, whereby said material is not intact solely due to the hollow channel, or whereby said material is not intact solely due to the hollow channel for the tensioning means that act orthogonally to the parting plane, and
b. the front chamber of a near-side wooden panel in each case forms a common chamber open at the top with the front chamber of the wooden panel located on the remote side of the abutment axis, and
c. wherein the tensioning means is anchored in the rear chamber at each end by means of a screw head or tensioning block, and
d. a continuous threaded connection is realized via the hollow channels and common chamber, which threaded connection is tensioned in the common chamber by means of fixed-location rotation of a sleeve, by a coupling including a central nut and two threaded pipe sections which can be pulled together by said nut, or by a nipple.

According to an advantageous embodiment, the wood-concrete composite slab according to the invention comprises any combination of features according to one or more of sections [0020] to [0025], [0029] to [0036], [0040] to [0052] and one or more of the features presented in the following sections [0057] to [00111], viz:
wherein the wood layer is left free of material-removing machining in the wood and thus intact in a bottommost layer portion, or the wood layer is left free of material-removing machining in the wood in a portion of its layer that is bottommost in relation to the layer thickness, and thus is left intact, or the wood layer is left free of material-removing machining in the wood and thus intact in a bottommost portion of its layer thickness;
wherein the at least one bearing means is reinforced;
wherein the at least one bearing means is made of reinforced concrete;
wherein at least one shear connector or each shear connector traversing the insulating layer or each shear connector of the composite slab connects a bottommost support layer to an uppermost support layer of the composite;
wherein the wood layer is designed as the bottommost support layer that can be subjected to tensile load in the composite slab and/or the concrete layer as the uppermost support layer;
wherein shear forces occurring between the wood layer and the concrete layer can be absorbed by the shear connectors in at least two distinct directions or can be absorbed by the shear connectors in increased measure in at least two distinct directions or can be absorbed by the shear connectors in at least two distinct directions that are perpendicular to one another, or can be absorbed by the shear connectors in increased measure in at least two distinct directions that are perpendicular to one another, or shear forces occurring between the wood layer and the concrete layer can be absorbed by the shear connectors in increased measure in two distinct directions, viz., in those two directions which are perpendicular to one another in which the shear connectors form rows, or shear forces occurring between the wood layer and the concrete layer can be absorbed by the shear connectors in increased measure, viz., in those two directions that are perpendicular to one another in which the shear connectors form rows;
wherein shear forces occurring between the wood layer and the concrete layer can be absorbed in any direction, or wherein shear forces occurring between the wood layer and the concrete layer can be absorbed in any direction by the shear connectors;
wherein at least one shear connector or each shear connector traversing the insulating layer or each shear connector of the composite slab simultaneously protrudes into the wood layer and into the concrete layer and is thereby held in the wood of the wood layer and in the concrete of the concrete layer;
wherein at least one shear connector or each shear connector traversing the insulating layer or each shear connector of the composite slab leads over a one-piece portion of the wood layer into the concrete layer;
wherein at least one shear connector or each of the shear connectors traversing the insulating layer or each shear connector of the composite slab is installed in the wood layer and the concrete layer in a positive-locking manner and thus without play, so that the shear connector is embedded unalterably and non-deformably;
wherein at least one shear connector or each shear connector traversing the insulating layer or each shear connector of the composite slab has such a shape that, in order to create a shear-resistant connection between the wood layer and the concrete layer, it can be installed in an unchanged manner or can be installed unchanged in its shape;
wherein at least one shear connector or each shear connector traversing the insulating layer or each shear connector of the composite slab is not designed as a stirrup;
wherein at least one shear connector or each shear connector traversing the insulating layer or each shear connector of the composite slab is not a perforated sheet;
wherein at least one shear connector or each shear connector traversing the insulating layer or each shear connector of the composite slab is designed as a tube, as a profile, or extruded profile, i.e., a profile from an extrusion method;
wherein at least one shear connector or each shear connector traversing the insulating layer or each shear connector of the composite slab is designed as a tube with or without a flange, wherein the tube has or forms a tube portion with a round or elliptical cross-section or a tube portion in the form of a polygonal tube;
wherein at least one shear connector or each shear connector traversing the insulating layer or each shear connector of the composite slab is designed in one piece;
wherein at least one shear connector or each shear connector traversing the insulating layer or each shear connector of the composite slab protrudes with its one end portion into the wood layer and with its other end portion into the concrete layer, and thus is fully embedded in the wood and concrete;
wherein at least one shear connector or each of the shear connectors passing through the insulating layer or each shear connector of the composite slab runs outside of the at least one bearing means or is not embedded in the at least one bearing means and/or runs outside of channels of the wood layer filled with concrete or is not embedded in channels of the wood layer filled with concrete, and/or runs outside of projections of the concrete from the concrete layer—in particular, downward projections of the concrete—or is not be embedded in projections of the concrete from the concrete layer—in particular, downward projections of the concrete;
wherein at least one shear connector or each shear connector passing through the insulating layer or each shear connector of the composite slab does not form a part of a bearing means or is not connected to the same or is not designed as a bearing means and/or does not form part of a channel of the wood layer filled with concrete or is not present as such or is not connected to such, and/or does not form a part of a projection of the concrete from the concrete layer—in particular, a downward projection of the concrete—or is not present as such, or is not connected to such;
wherein shear connectors having a weight proportion of at least 50% or of at least 60% or of at least 70% or of at least 75% or of at least 80% or of at least 90% or all shear connectors installed in the slab run outside of or are installed outside of the at least one bearing means and/or outside of channels of the wood layer that are filled with concrete and/or outside of projections of the concrete from the concrete layer—in particular, downward projections of the concrete;
wherein the wood layer is designed without channels;
wherein shear connectors held within the wood layer and within the concrete layer are mechanically installed in the composite slab, or the shear connection between the wood layer and the concrete layer is realized exclusively by mechanically built-in shear connectors which are held within the wood layer and within the concrete layer, whereby the shear connection is not realized either via a positive connection or via a surface bond;
wherein the at least one shear connector or each of the shear connectors traversing the insulating layer or each shear connector of the composite slab is held within the wood layer by means of pressing in and/or gluing;
wherein at least one shear connector that protrudes with its end portions into the wood layer and into the concrete layer leads directly through the insulating material of the insulating layer and is thus enclosed on all sides, wherein the insulating material does not consist of air;
wherein each of the shear connectors passing through the insulating layer and protruding with its end portions into the wood layer and into the concrete layer leads directly through the insulating material of the insulating layer and is thus enclosed on all sides, wherein the insulating material does not consist of air;
wherein the insulating layer is of the same thickness up to and/or except for the shear connectors passing through it and any bearing means that may be present;
wherein the insulating material of the insulating layer is completely held by the wood layer and therefore manages without a lower formwork;
wherein the wood layer can be subjected to tensile loads in the direction of load transfer if the slab has a uniaxial load-bearing effect, i.e., if the slab has uniaxial load transfer;
wherein the wood layer can be subjected to tensile load over the maximum span of the slab;
wherein the wood layer can be subjected to tensile load over the entire length or along the entire length of the at least one bearing means;
wherein the wood layer is configured so that it does not need to rest on one or more bearing means running below it;
wherein the wood layer is configured in such a way that it does not need to rest on one or more bearing means designed as wood beams running below it or bearing means designed as wood beams;
wherein the bottommost layer portion of the wood layer extends over the entire wood layer;
wherein the wood layer with its bottommost layer portion terminates towards the bottom;
wherein the wood layer forms a continuous soffit with its bottommost layer portion;
wherein the wood layer includes abutting wooden panels or is formed as such;
wherein the recess is created, by material removal, in such a way that it forms at least one box-shaped space within the wooden panel as seen from above;
wherein the tensioning of the at least two abutting wooden panels reciprocally tensioned against one another causes them to be tensioned against one another with a permanent tensioning force and not just held in position relative to one another;
wherein the tensioning of the at least two abutting wooden panels reciprocally tensioned against one another is realized in each case over a panel region on both sides of a parting plane of the two wooden panels tensioned against one another, which panel region includes only a part of a length of the wooden panel in the tensioning direction;
wherein the bottommost layer portion of the wood layer itself forms a layer which has a height;
wherein the wood of the bottommost layer portion of the wood layer has a seamless, continuous design as far as seams at locations and/or along the parting planes which run perpendicular to the tensioning direction of the wooden panels that are tensioned against one another;
wherein the wood layer on its underside is left free of material-removing machining and thus is left intact;
wherein the wood layer on its underside is left free of engagements or incisions or milled-out portions and thus is left intact;
wherein the underside delimiting the wood layer forms an intact slab soffit;
wherein the wood layer terminates at the bottom as a flat slab soffit;
wherein the bottommost layer portion has an extension at the top or a height;
wherein the extension of the bottommost layer portion towards the top, or the height of the bottommost layer portion measures at least 5 mm or at least 10 mm or at least 15 mm or at least 20 mm or at least 25 mm;
wherein the wood layer is not composed of wood beams arranged in a row, or the wood layer does not consist of components in the form of individual wood beams, or the wood layer does not include any components in the form of individual wood beams;
wherein the wood layer made of a wood material is produced from cross-laminated timber, laminated veneer lumber, or solid wood;
wherein the wood layer is not formed from Brettstapel;
wherein the wood layer is not formed from wood chips;
wherein the layer course of the slab continues on both sides of the at least one bearing means;
wherein the at least one bearing means or a projection of the concrete of the concrete layer—in particular, a downward projection of the concrete—adjoins the wood layer in a flush manner;
wherein shear connectors are installed in the composite slab, of which at least one shear connector simultaneously protrudes into the wood layer and into the concrete layer and thereby passes through the insulating layer;
wherein the wood layer in the slab composite is subjected to tensile loading in the installed state of the slab;

In addition, the invention relates to a building comprising one or more installed wood-concrete composite slabs having any combination of features according to one or more of sections [0020] to [0025], [0029] to [0036], [0040] to [0052], [0056] to [00111].

An advantageous embodiment of the invention relates to a building having the combination of features according to section [00112], wherein it is designed as a residential and/or office building, administrative building, educational facility, exhibition hall or civic center, conference and concert hall, library, museum, repository, shopping center, hotel, aquatics center, sports stadium, train station, or airport.

A further advantageous embodiment of the invention relates to a building having the combination of features according to any of sections [00112] or [00113], wherein it is designed as a high-rise building with a total height starting at 25 m.

A further advantageous embodiment of the invention relates to a building according to one or more of sections [00112] to [00114] with one or more built-in wood-concrete composite slabs having any combination of features according to one or more of sections [0020] to [0025], [0029] to [0036], [0040] to [0052], [0056] to [00111], wherein the slabs are installed in a horizontal position and/or in an oblique position up to 45° or in an oblique position up to 60°.

An advantageous embodiment of the invention also relates to a method having any combination of features according to one or more of sections [0026] to [0028], [0038] to [0039], [0053] to [0055].

A further advantageous embodiment of the invention relates to a method having any combination of features according to one or more of sections [0026] to [0028], [0038] to [0039], [0053] to [0055] for creating a wood-concrete composite slab having any combination of features according to one or more of sections [0020] to [0025], [0029] to [0036], [0040] to [0052], [0056] to [00111].

A further advantageous embodiment of the invention relates to a method having any combination of features according to one or more of sections [0026] to [0028], [0038] to [0039], [0053] to [0055] for the creation of a building having any combination of features according to one or more of sections [00112] to [00115].

In addition, an advantageous embodiment of the invention relates to a use having the combination of features according to section [0037] in a wood-concrete composite slab having any combination of features according to one or more of sections [0020] to [0025], [0029] to [0036], [0040] to [0052], [0056] to [00111].

A further advantageous embodiment of the invention relates to a use having the combination of features according to section [0037] in a wood-concrete composite slab having any combination of features according to one or more of sections [0020] to [0025], [0029] to [0036], [0040] to [0052], [0056] to [00111], which is built into a building having any combination of features according to one or more of sections [00112] to [00115].

The object of the invention is also achieved by a wood-concrete composite slab having the features according to any of claims 1, 10, or 20. Advantageous embodiments of the wood-concrete composite slab according to the invention are described in dependent claims 2 to 6, 11 to 16, 21 to 30, and 34 to 86. The object is also achieved by a method having the features according to any of claims 7, 18, or 31 and advantageous embodiments of the method according to claims 8 to 9, 19, 32 to 33, and 91 to 93. Furthermore, the object of the invention is achieved by a use according to claim 17 or as an advantageous embodiment of the use according to any of claims 94 or 95. The object is also achieved by a building according to claim 87 and advantageous embodiments of the building according to claims 88 to 90.

Because large spans can be spanned with the wood-concrete composite slab according to the invention and at the same time have an attractive appearance, they can find extremely wide and versatile application, not only in residential buildings, but also in office buildings and public administration buildings—in particular, with open plan office design—in schools and educational facilities, but also in especially large-sized buildings such as meeting facilities, exhibition halls and civic centers, conference and concert halls, libraries, museums, repositories, shopping centers, hotels, aquatics centers, sports stadiums, train stations, and airports, just to name a few such buildings with typically large-area slabs. A typical field of use of the slab according to the invention relates to multi-story construction—in particular, high-rise construction—because, as a rule, apartments and/or office units are to be accommodated there of different sizes and varying layouts, and the slab offers this flexibility thanks to the spanned dimension that can be realized therewith. In contrast to a conventional slab system, the wood-concrete composite slab according to the invention also brings with it relief to the support structure and foundation of the building—especially in high-rise buildings. And even if high requirements are placed on sound protection, the slab design according to the invention can stand out due to its comparatively lightweight design. In this way, it simultaneously meets modern demands for sustainable, low-impact construction and living quality, and is therefore excellently suited for urban multi-story construction and high-rise construction. The height of a building at which it qualifies as a high-rise building according to the applicable standards usually varies between about 25 and 50 meters for its overall height. In the following, a high-rise building is always understood to be a building starting at an overall height of about 25 meters. It goes without saying that the slab according to the invention can also be installed advantageously in less complex or less requirement-heavy building structures, and its application area generally, although not exclusively, relates to the high-rise construction.

In the figures, the wood-concrete composite slab according to the invention and a building having one or more such built-in slabs are illustrated based upon exemplary embodiments, and their peculiarities and their production are described and explained in detail in the following description.

In the drawings:

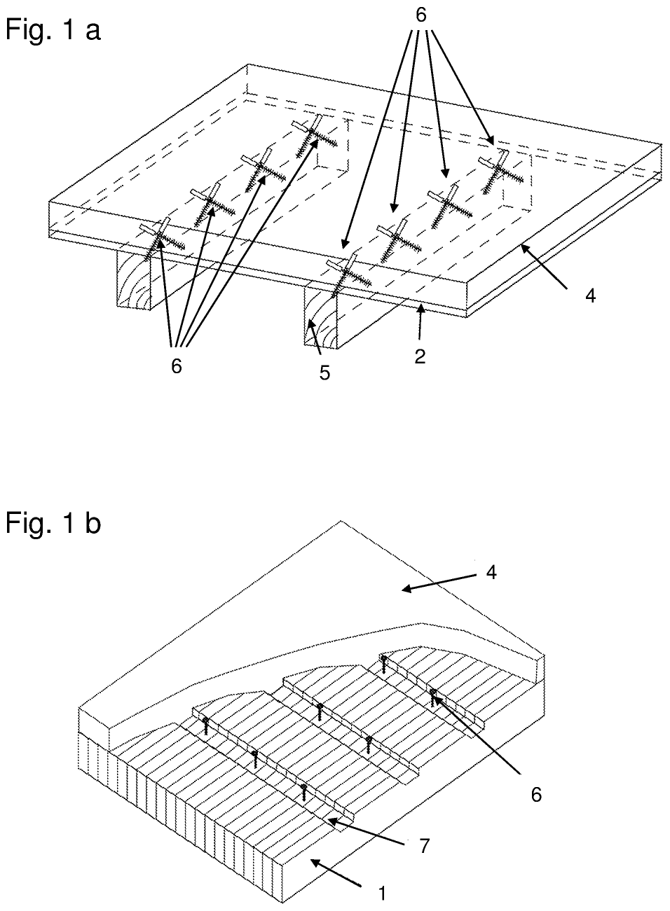

FIG. 1 a: shows an example of a conventional wood-concrete composite slab with linear wood components and connecting elements running along the same, in a perspectival plan view;

FIG. 1 b: shows an example of a conventional wood-concrete composite slab with a planar wood element made of Brettstapel with connecting elements running in grooves of the same, shown partially cutaway in perspectival plan view;

FIG. 2 a: shows a cross-section through the layer construction of an embodiment of the wood-concrete composite slab according to the invention having a reinforced concrete bearing means embedded internally in the slab;

FIG. 2 b: shows a cross-section through the layer construction of an embodiment of the wood-concrete composite slab according to the invention having an bearing means embedded internally into the slab, which bearing means includes a steel beam;

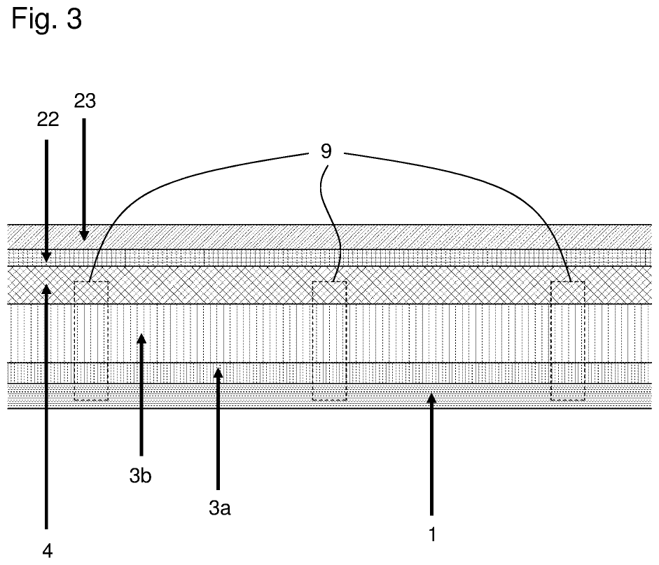

FIG. 3: shows a cross-section through the layer construction of a further embodiment of the wood-concrete composite slab according to the invention with a two-layer insulating layer;

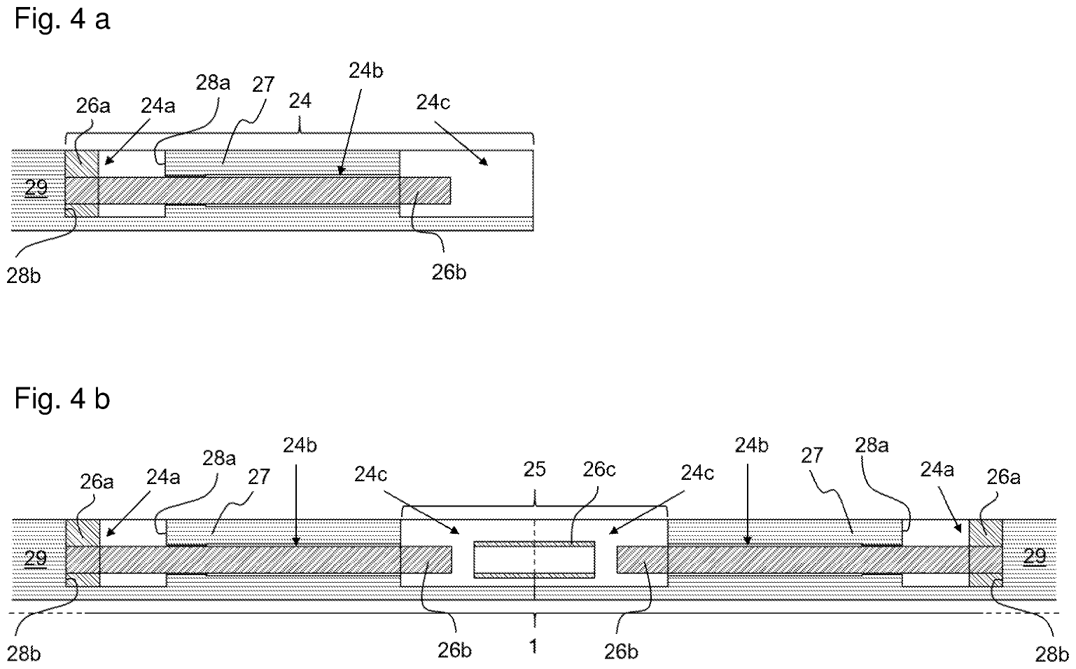

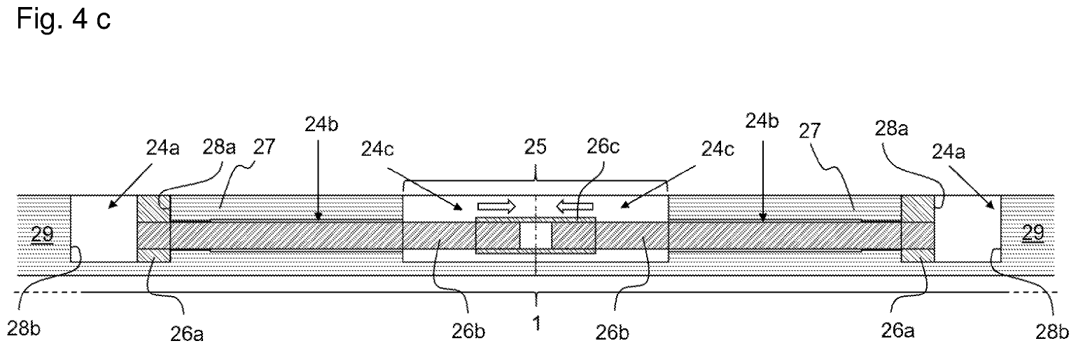

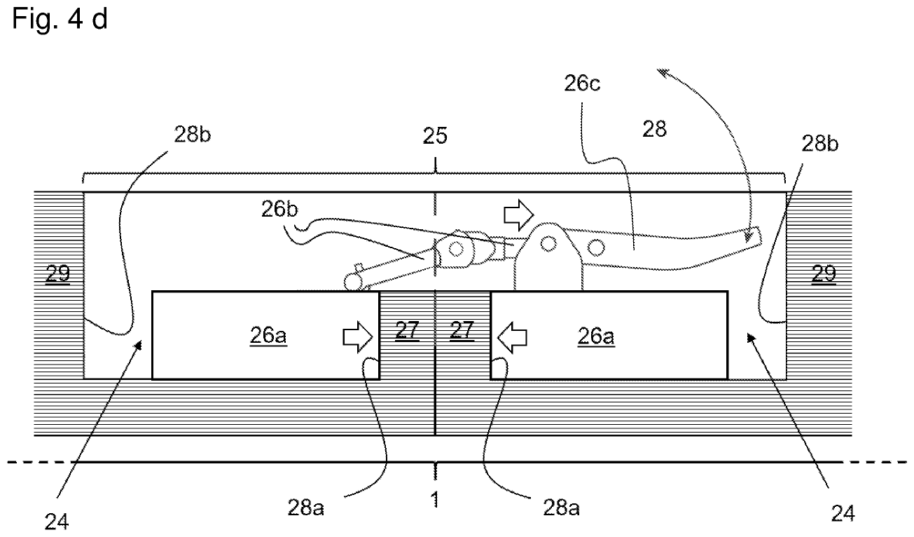

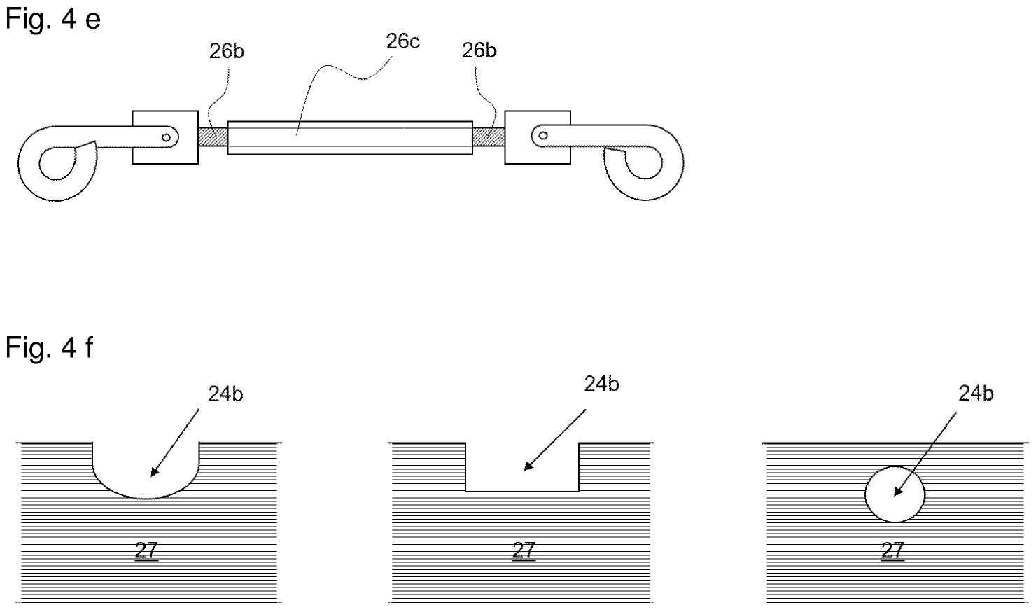

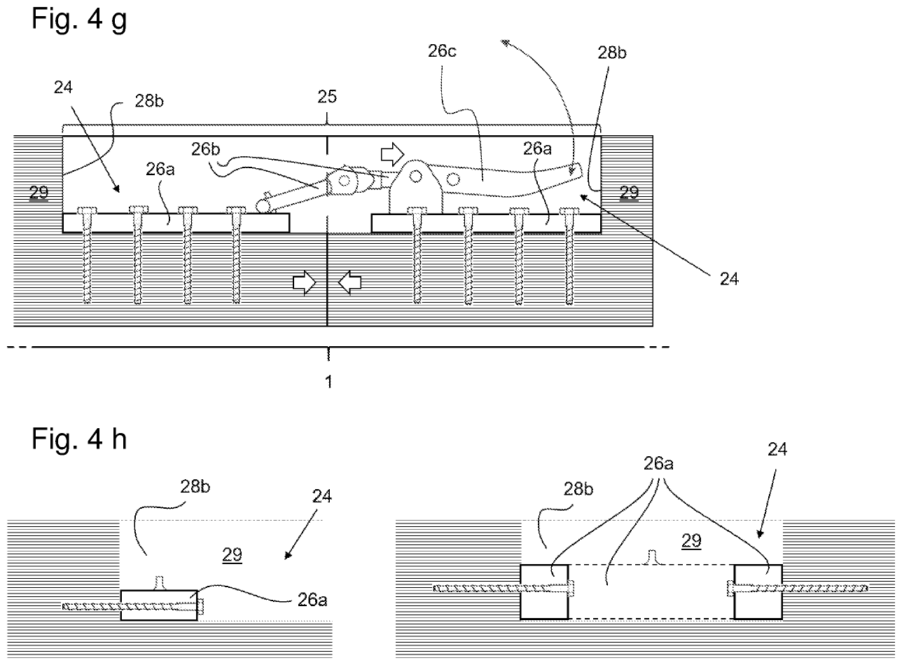

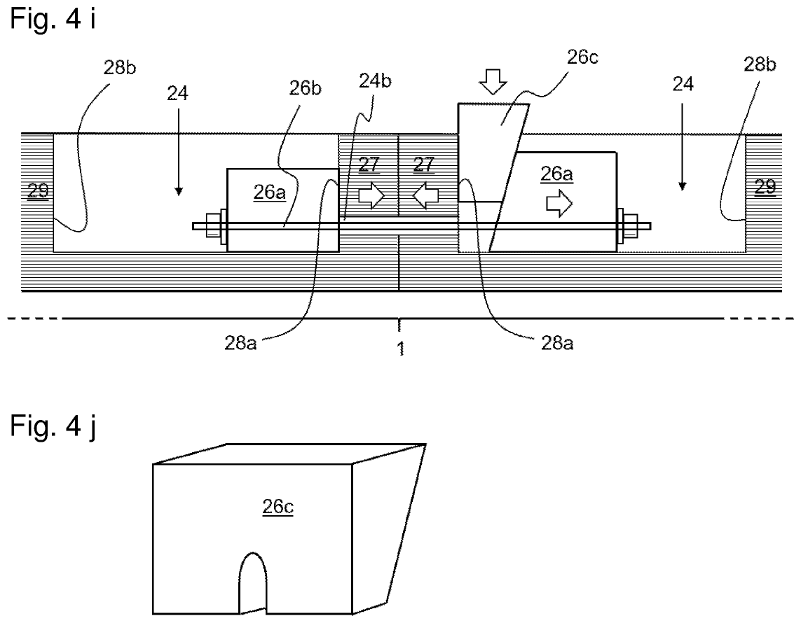

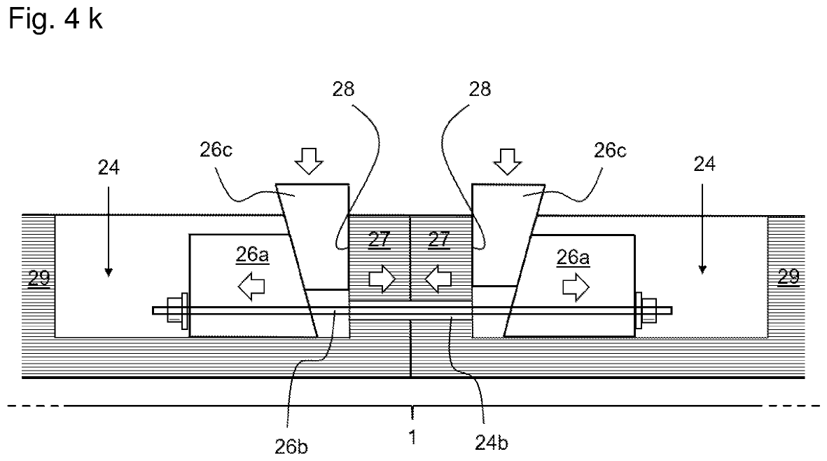

FIG. 4 a: shows a longitudinal section through a wooden panel with a loosely inserted anchor for the tensile-force connection to a further wooden panel;

FIG. 4 b: shows a longitudinal section through two abutting wooden panels, before producing a tensile-force connection of the wooden panels;

FIG. 4 c: shows the longitudinal section through the configuration according to

FIG. 4 b, but now with wooden panels tensioned to one another in a frictional manner;

FIG. 4 d: shows a longitudinal section through two abutting wooden panels, which are tensioned against one another with a loosely inserted tensioning lock;

FIG. 4 e: shows a tension spindle with threaded rods and a sleeve running thereon;

FIG. 4 f: shows a cross-section through the spared/remaining/untouched front intact material of a wooden panel, with differently shaped incisions or milled-out portions for the tensioning means connection, with a view in the direction of the abutment axis relative to the parting plane of the wooden panels;

FIG. 4 g: shows a longitudinal section through two abutting wooden panels, which are tensioned against one another with a tensioning closure screwed into the wooden panels;

FIG. 4 h: shows a cross-section through a recess in a wooden panel with a laterally anchored tensioning block;

FIG. 4 i: shows a longitudinal section through two abutting wooden panels which are tensioned against one another by wedge tensioning;

FIG. 4 j: shows a tensioning wedge having a U-shaped incision or milled-out portion, whereby it can be slipped over a threaded rod;

FIG. 4 k: shows a longitudinal section through two abutting wooden panels that are tensioned against one another in a tensioning arrangement which is symmetrical along the parting plane of the wooden panels;

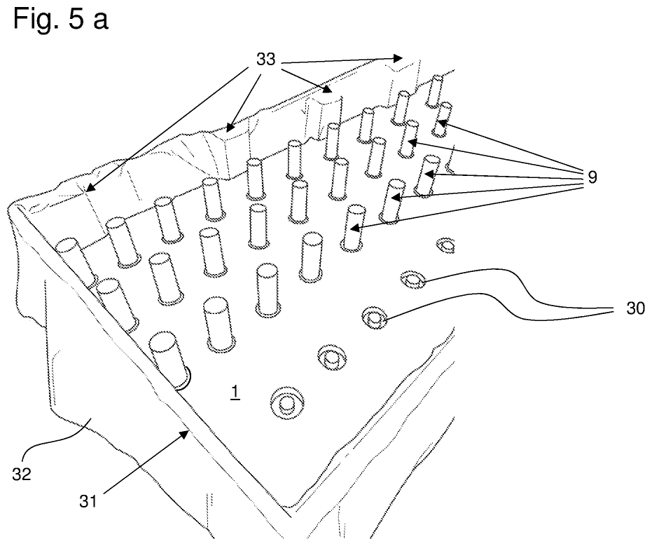

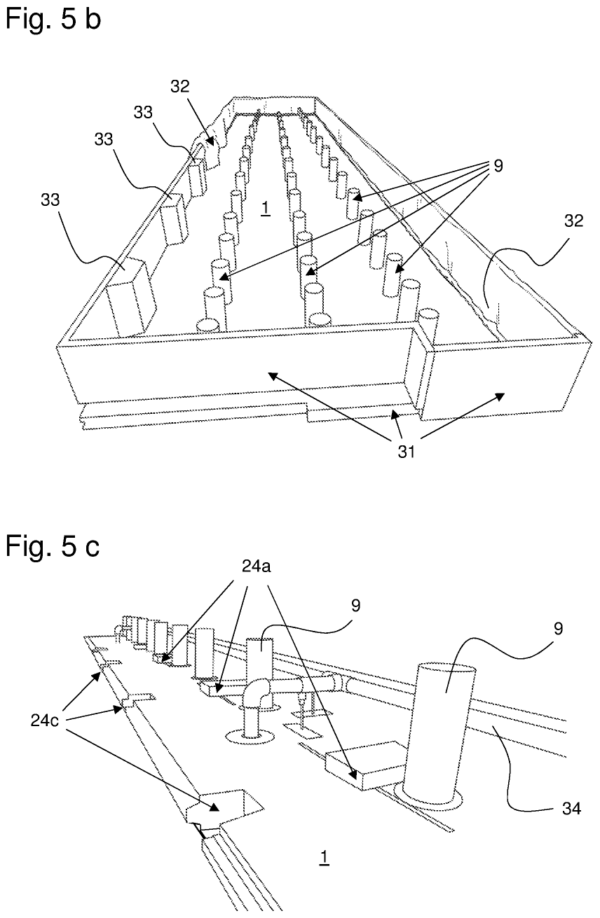

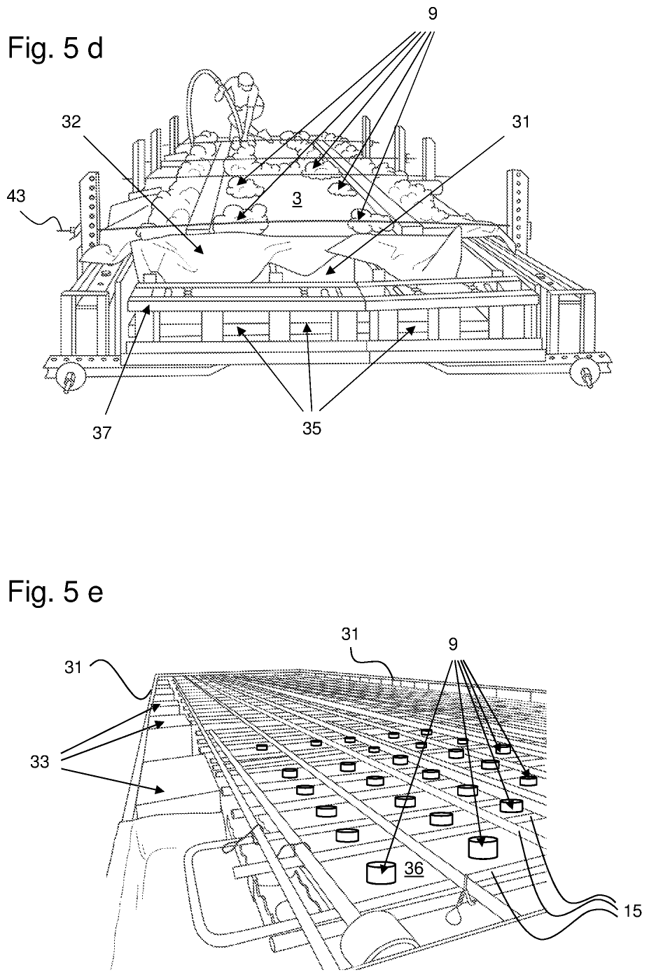

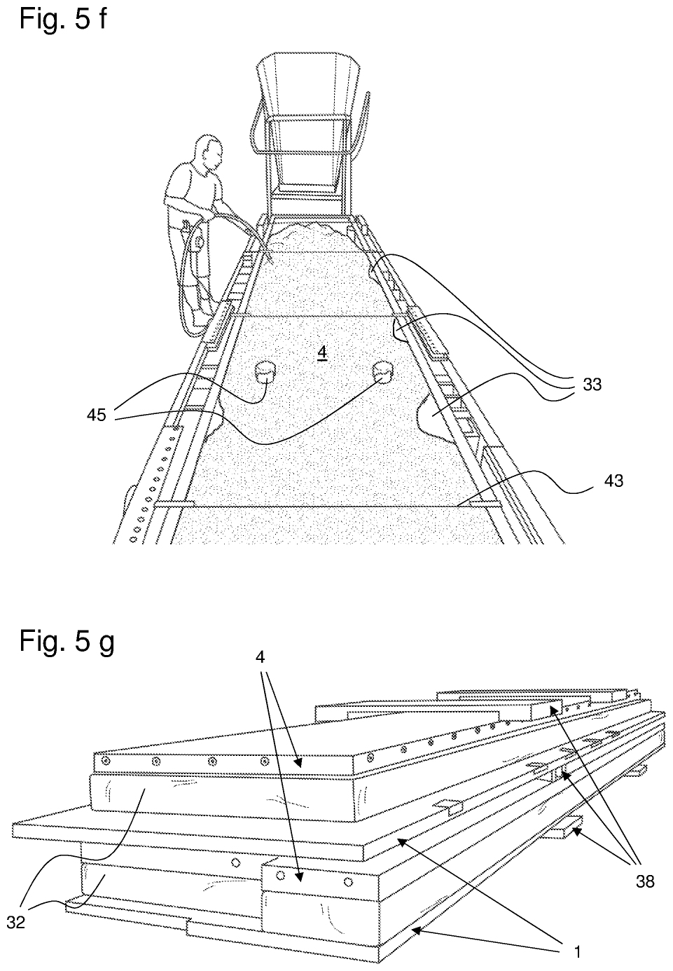

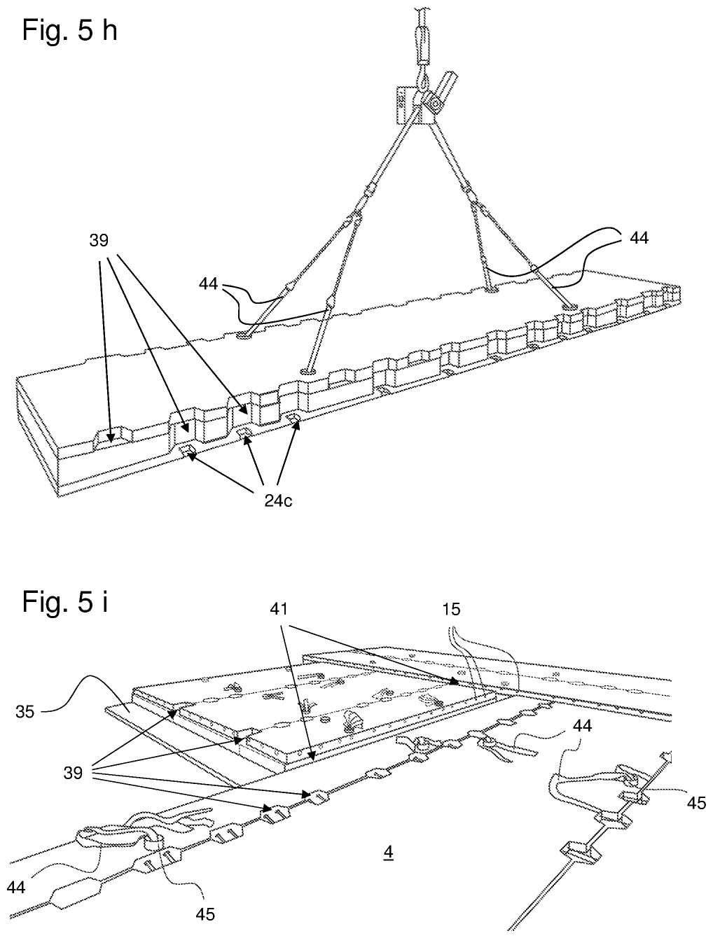

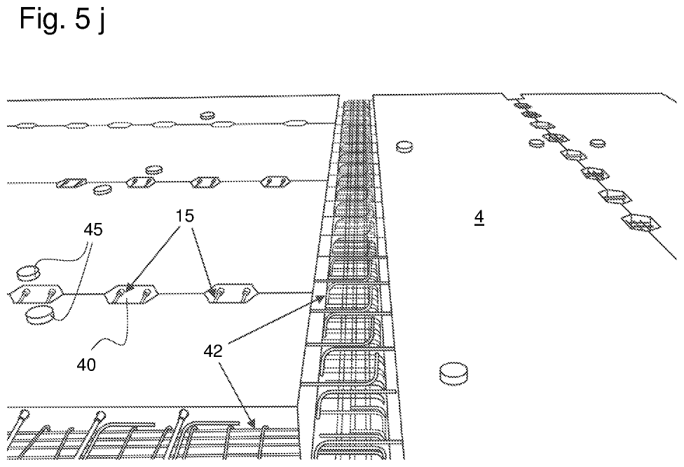

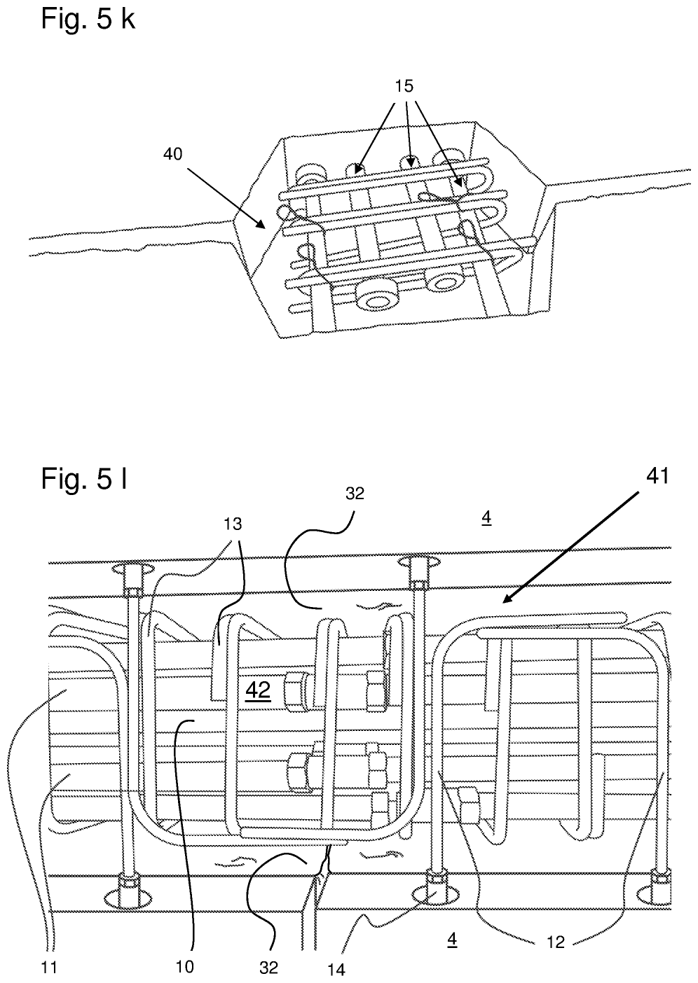

FIG. 5 a-m: shows a method for producing a wood-concrete composite slab according to the invention in chronological sequence;

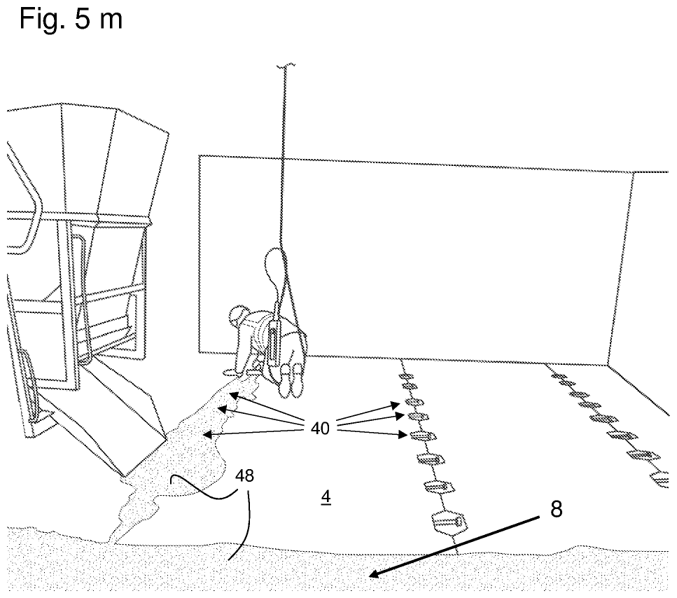

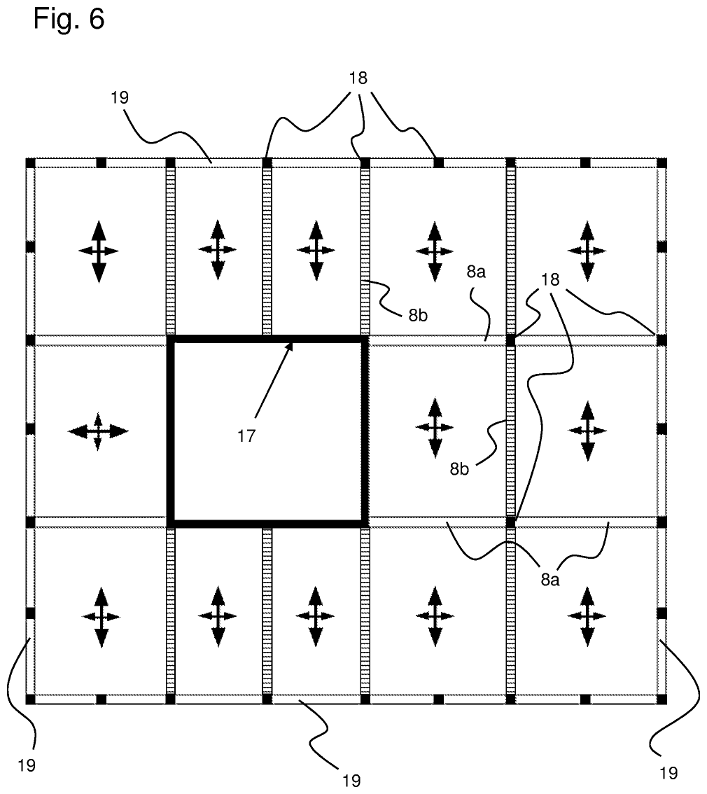

FIG. 6: shows a schematic support structure concept of a wood-concrete composite slab according to the invention on the basis of an exemplary slab plan, with advantageously arranged internal bearing means;

FIG. 7: shows a cross-section through a wood-concrete composite slab according to the invention with an internal bearing means, with a view of columns adjoining the slab at the top and bottom, and which run behind the drawing plane;

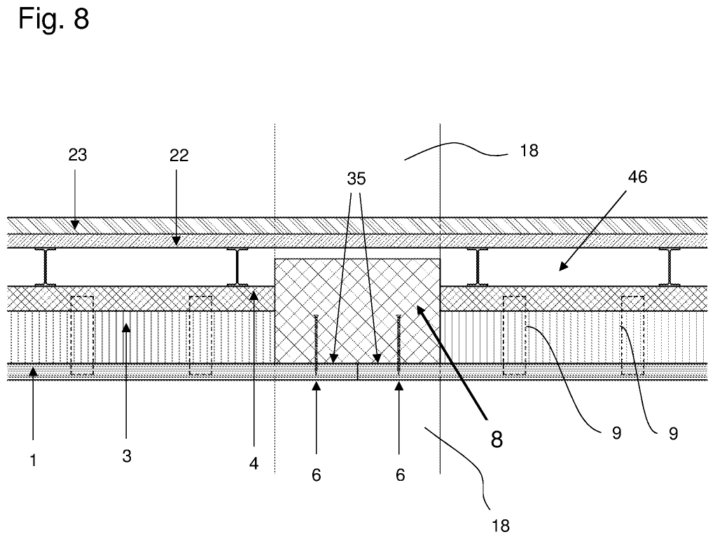

FIG. 8: shows a cross-section through a wood-concrete composite slab according to the invention with a bearing means, which is embedded internally in the slab and projects upwards, the projection of which is integrated into a hollow slab, with a view of columns adjoining the slab at the top and bottom, and which run behind the drawing plane;

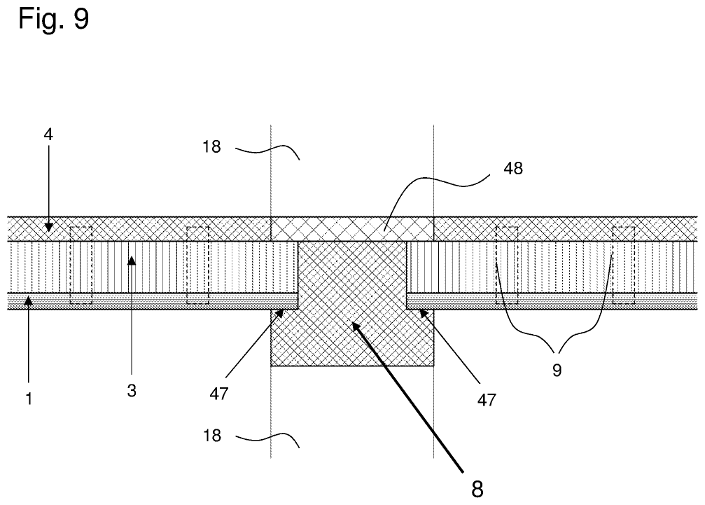

FIG. 9: shows a cross-section through a wood-concrete composite slab according to the invention with a bearing means which is embedded internally in the slab and projects at the bottom, with a view of columns adjoining the slab at the top and bottom and which run behind the drawing plane;

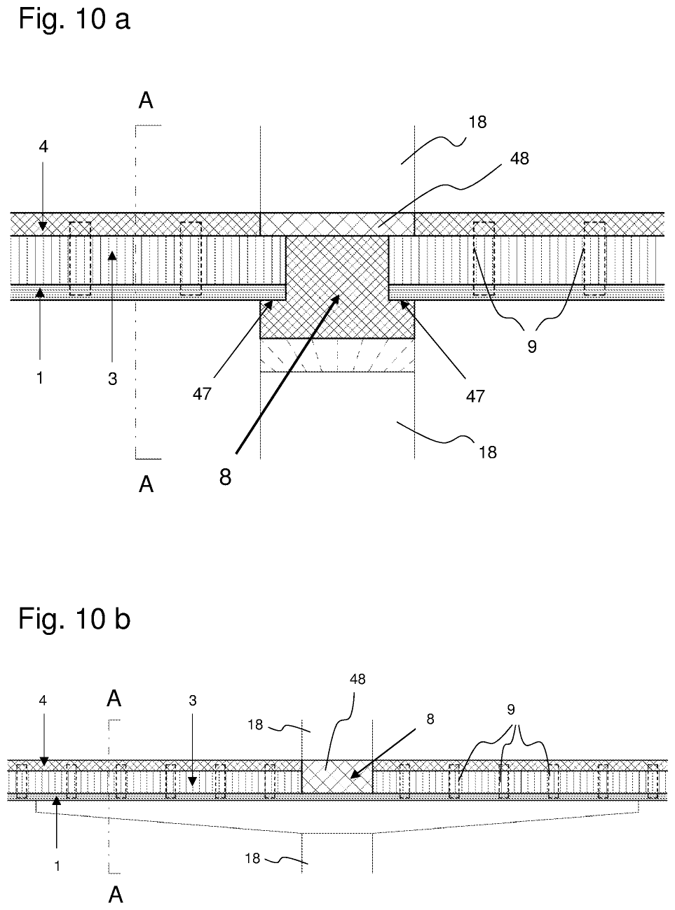

FIG. 10a: shows a cross-section analogous to FIG. 9, wherein the projection of the internal bearing means is designed as an arm of a capital, which extends from the lower column on both sides perpendicularly to the sheet plane and whose inclination downward towards the column is indicated on the side visible here with dashed auxiliary lines;

FIG. 10 b: shows a section through the support configuration according to the section line A-A in FIG. 10 a, with a view of the capital extending behind the drawing plane according to its length, wherein the corresponding associated part of the bearing means connecting at the top, as can be seen in FIG. 10 a, is covered by the layer composite of the slab running in the sheet plane, and the slab includes two further, internally guided bearing means, which extend away from the upper column on both sides perpendicularly to the sheet plane, of which one bearing means can be seen in cross-section;

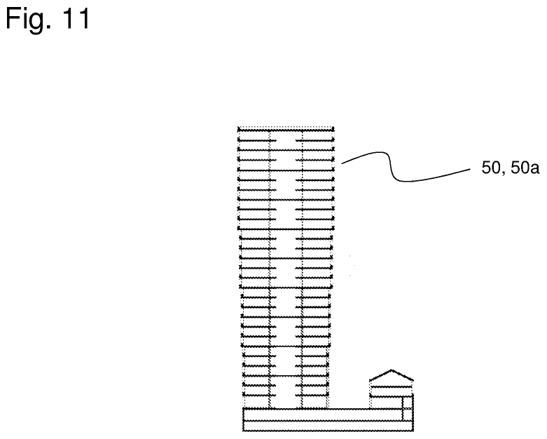

FIG. 11: shows the slab plan of a building having at least one, and typically a plurality of, built-in wood-concrete composite slabs according to the invention.

For the present disclosure, some terms are defined below:
Wood-concrete composite slab: a slab whose support structure comprises a component of concrete (concrete element) and a component of wood (wood element) connected thereto in a shear-resistant manner;
Shear connection in a wood-concrete composite slab: shear-resistant connection which offers sufficient resistance to shearing of the concrete support element from the wood support element;
Layer: a uniform mass (i.e., not infiltrated by other types of masses or a mass affected by a material change taking place via the extension of the layer) having a height in planar extension lying within a certain height above, below, or between others, and thus alongside the planar extension;
Wood layer of the wood-concrete composite slab: a layer of wood/planar wood element/wood extended in a planar orientation in the composite of said slab, in contrast to wood in timber form;
Support elements: these are distinguished by, in addition to their shape, the type of load transfer in bar-type and surface support structures or columns, beams, or brackets (bar-type support structures) and sheets, panels, and shells (surface support structures);
Rods: one-dimensional, i.e., linear, elements are rods whose cross-sectional dimensions for the width (b) and for the height (h) are small compared to their length (I). Generally, the following applies as a boundary range: I≥2b and I≥2h;
Columns: rods predominantly loaded in their axis;
Beams: rods stressed predominantly perpendicular to their axis, i.e., by bending;
Slab bearing means: beam that accommodates the slab load and diverts it to other components;
Support layer: a component, designed as a layer, of the support structure.

First, a cutout of a conventional wood-concrete composite slab having linear wood components is described and explained with reference to FIG. 1 a. In the example shown, following from bottom to top, are, first, the wood beams 5 that visibly protrude into an interior of the building and are arranged spaced apart from one another, and, then, a permanent concrete formwork 2, and, finally, the concrete layer 4. A number of wood-concrete connecting elements 6, in this case in the form of screws 6 which are arranged in a regular manner at an oblique angle along the wood beams 5 and cross in pairs, pass through the composite. The formwork 2 simultaneously marks the parting plane between the wood support structure and the concrete layer 4 created over it, into which the upper portions of the screws 6 are cast and generate a shear-resistant connection to the wood beams 5. A minimal reinforcement (not visible in FIG. 1 a) is cast into the concrete layer 4, for absorbing tensile stresses and for minimizing cracks in the concrete. The wood beams 5 are predominantly subjected to tensile stress, while the concrete of the concrete layer 4 is predominantly subjected to compression.

FIG. 1 b shows a cutout of an alternative embodiment of a conventional wood-concrete composite slab, viz., a planar wood-concrete composite slab. The wood support structure is designed as a planar wood element or as a wood layer 1, mostly made of a wood material, such as cross-laminated timber, glue-laminated lumber, laminated veneer lumber, or solid wood. In the example shown here, the wood layer 1 is formed from board layers which are arranged vertically one after the other and stacked edgewise on top of one another and are also Brettstapel elements. For a glue-free joining of these elements, kiln-dried hardwood dowels are installed into the elements perpendicular to their surface, and precise-fit boreholes are introduced into the respectively adjacent elements. After the outer-dry dowels have been inserted into the boreholes of the respectively adjacent Brettstapel element, when the wood dowels are enriched with moisture, they swell up and are thus compressed within the boreholes. Grooves or channels 7 spaced apart from one another are made in the wood layer 1 formed in this way. Connecting elements 6, here in the form of dowels or screws, are introduced therein as shear connectors perpendicular to the slab surface. After the concrete layer 4 has been created, the channels 7 then filled with concrete act with their connecting elements 6 as shear joints. Also in this embodiment of the wood-concrete composite slab, a minimum reinforcement is inserted into the concrete layer 4 for absorbing the tensile stresses and avoiding cracking. Such a conventional planar wood-concrete composite slab can well be realized in single-family buildings or other buildings having small slab spans and low protection specifications. The larger the slab construction becomes, and the higher the protection specifications of a building are, the less worthwhile it is to use them.

In order to be able to expediently use conventional wood-concrete composite slabs in multi-party buildings, high-rise buildings, or other large-sized buildings, greater requirements for their load-bearing capacity are set—in particular, if large/long spans are to be realized. As explained at the outset, the design thickness of the slab, i.e., its height, must then be more pronounced so that it becomes more flexurally rigid. For a conventional slab structure as shown in FIG. 1 b, this means that the load-bearing composite layers have to be designed to be higher or thicker, which makes the slab solider and heavier. In a cost distribution according to slab composite partners (including wood, concrete, shear bond, and secondary works), only about 60%, or, in phases of high raw material prices, even more, can be dispensed with just in terms of the proportion of wood. A thicker wood layer 1 then leads to the slab becoming substantially more expensive. If instead, mainly or even only the concrete layer 4 is made thicker, then the wood partner, as a comparatively thin layer, will soon no longer be able to make the contribution to the composite that was actually intended for it. The concrete wood ratio in the composite becomes worse. The question then arises of the useful value of the comparatively expensive wood layer 1 in a slab, which, given the amount of concrete required, could also be made entirely of concrete. However, if a classic concrete slab is installed, the elimination of the wood layer 1 results in a significantly higher intrinsic weight. For comparison: reinforced concrete has a density of about 2.5 t/m³, whereas that of the wood and wood materials are accordingly 3-10 times less (e.g., spruce wood: 0.35 t/m³). It is consequently found that the increase or extension of the span of a slab can only be realized using substantially more material, which, overall—and especially in the case of high concrete use—is of consequence. In the case of proportional increase in the composite layers of a planar wood-concrete composite slab, a 50% extension of the span, e.g., from 6 m to 9 m, is accompanied by an increase in weight of the slab, which is about 50% to 70%, depending upon the span. With the embodiments of the wood-concrete composite slabs according to the invention described below, a 50% extension of the span, e.g., from 6 m to 9 m, can be realized with a weight increase, depending upon the span, of 10% or less. The slab thickness varies by only about 5-10 cm. Typically, the span-dependent weight increase for a 1.5-fold increase in the slab span—approximately from 6 m to 9 m—is only about 5-7% of the slab weight—with a variation of the slab thickness of about 5-7 cm. This makes possible a flexibility in the slab plan design hitherto unknown for wood-concrete composite slabs.

FIG. 2 a shows a cross-section through the layer construction of an embodiment of the wood-concrete composite slab according to the invention having a planar wood element. In this embodiment, it has as a special feature a linear bearing means which is enclosed within the spatial extension of the slab and is consequently referred to below as an “internal bearing means.” In this case, it passes through at least the concrete layer 4 and the insulating layer 3, and thus interrupts the layer construction 3, 4 of the slab so that the composite layers 3, 4 spatially adjoin each lateral flank 16 of the bearing means 8 thereof, i.e., adjoin it on both sides, which extends in its length perpendicularly to the sheet plane in FIG. 2 a. In the present embodiment, the height H of the internal bearing means 8 made of reinforced concrete is 280 mm, and its width W measures 600 mm. This dimensions of the bearing means 8 are to be understood here merely as exemplary dimensions. They are selected in accordance with the building-specific requirements, but typically lie within the ranges between 300 mm and 700 mm for the width of the bearing means 8 and between 150 mm and 350 mm for its height. The bearing means 8 adjoins the concrete layer 4 in a surface-flush manner and extends downwards as far as the planar wood element, i.e., the wood layer 1. In a variant of the internal bearing means 8 which projects from the slab, as will be presented later, its height usually measures between 400 and 700 mm. Depending upon requirements, the bearing means 8 in a slab are also combined with different dimensions or with and without a projection. As mentioned, the internal bearing means 8 presented here extends down as far as the wood layer 1, with which it is frictionally connected. In the present case, connecting elements 6 in the form of wood construction screws are introduced into the wood layer 1. These have been screwed here into the wood layer 1 at right angles and thus arranged within the bearing means 8 in a manner that saves as much space as possible. Accordingly, they can also be screwed in obliquely. The upper part of the connecting elements or wood construction screws 6 protruding from the wood layer 1 is cast into the concrete of the internal bearing means 8, whereby an intimate connection is produced between the concrete of the bearing means 8 and the wood layer 1. Other wood-concrete joining means 6, such as plug metals or composite dowels, can also be introduced or glued mechanically by hand, or else the internal bearing means 8 can be glued to the wood layer 1 in a planar manner. In relation to the wood subslab 1, the internal bearing means 8, which is frictionally connected thereto, acts as a coating, so to speak.

The use of wood-based materials, such as cross-laminated timber (CLT), and in particular also laminated veneer lumber (LVL), proves to be advantageous for the wood layer 1. Compared to fiber-parallel arrangements of laminate layers, those with a crosswise-laid portion basically lead to an increased directional independence of the laminate, and consequently to more stiffness and strength of the laminate as a whole. Sometimes, this allows a slender design of the wood layer 1. Glass- or carbon-fiber-reinforced variants of such cross-layered, wood-based materials are also suitable for a flexurally rigid wood layer 1. Preferably, an LVL of beech wood is used, which in German-speaking technical circles is referred to as “BauBuche.” Thanks to the extraordinarily high strength and stiffness, BauBuche can be processed into substantially thinner components compared to softwood materials. In a typical embodiment of the slab, the wood layer 1 forms a 60 mm thick—and thus only approximately half as thick—subslab, as in comparable planar wood-concrete composite slabs according to prior art.

An insulating layer 3 is accommodated in the intermediate space between wood layer 1 and concrete layer 4. In an advantageous embodiment variant of the invention, the insulating layer 3 is designed in multiple layers made of insulating materials of different densities or different specific weights, with the layer of greatest density situated below on the wood layer 1. This will be discussed later. As a result of the spacing of the upper concrete slab from the wood subslab 1, a static height is created which affords a large flexural rigidity. In the present example, this spacing or the height of the intermediate space is 170 mm and is usually also designed to be between 100 and 250 mm high—preferably between 120 mm and 190 mm—in other embodiments of the slab. Between the wood layer 1 and the concrete layer 4, shear connectors 9 in the form of steel pipes are installed vertically thereto in this embodiment. The load-bearing concrete and wood layer 1, 4 are connected to one another in a shear-resistant manner by this grid of steel tube couplings. Four-channel or multi-channel tubes or rolled profiles can also be used for this purpose, as long as they absorb the shear forces as reliable spacers or effectively prevent shear movements between the composite layers 1, 4. Depending upon the slab design, the dimensions of the aforementioned shear connectors 9 are usually between 200 mm and 350 mm in their length/height and between 50 mm and 150 mm in diameter or across their diagonal. The shear connectors 9 protrude at the top into the concrete layer 4, into which they are concreted. They protrude at the bottom into the wood layer 1. For this purpose, the shear connectors 9 are each inserted, glued, or embedded directly into a recess 30 in the wood layer 1. Alternatively, they can also be inserted indirectly, e.g., by welding them in a steel holder, wherein the steel holder then is glued or embedded into a recess 30 in the wood layer 1. In a variant that is environmentally friendly, because it is free of mortar and adhesives, an internal thread is milled into the wood layer 1 for each steel tube 9 to be used, in order to screw in a steel tube 9 with an end-side external thread. Depending upon the slab span and its payloads, usually between three and six steel pipes per m² are installed in a distributed manner corresponding to the shear flow.

Towards the top, the slab terminates with the reinforced concrete upper slab of concrete layer 4 and upper portion of the internal bearing means 8. The reinforcement 15 of the concrete layer 4 is extended with a bell butt joint 14 via a connection reinforcement 12 into the region of the internal bearing means 8. For the connection reinforcement 12, bent reinforcement rods are used here. A tensile reinforcement 10 and a pressure reinforcement 11, and a stirrup reinforcement 13 in the internal bearing means 8 as a typical bearing means reinforcement 42, are also shown schematically. A screed/subslab 23 underlaid with impact sound insulation 22 usually goes over the concrete upper slab. Optionally, a slab covering follows at the top on the screed 23. A slab constructed in this way including slab coverings on top of it can be realized with a total thickness of between 350 mm and 450 mm. In this way, it has a slim/thinner design than conventional planar wood-concrete composite slabs of the same load-bearing capacity, in which both the concrete layer and the wood layer have to be designed to be substantially stronger/thicker. For multi-story construction—in particular, high-rise construction—this has a decisive effect on the utilization of the building. At a predetermined building height of, for example, 80 meters, the slab according to the invention can easily achieve one to two stories more than with conventional wood-concrete composite slabs.

FIG. 2 b shows a cross-section through the layer construction of the wood-concrete composite slab according to the invention with an alternative embodiment of the internal bearing means 8. In the present case, said bearing means is designed with a steel beam 20 in a modified H-profile form and extends over its length on both sides perpendicular to the sheet plane of FIG. 2 b. Compared to the lower flange 21b, the upper flange 21a of the profile 20 deliberately has shorter wings, so that the wood construction screws 6 can be screwed into the wood layer 1 in situ during the assembly of the bearing means 8, and the access for this purpose is open. Other profile shapes are also possible, e.g., reversed T-beams, L-beams, etc., which are supported on the wood layer 1 with their flange 21b and can be screwed or glued thereto. However, a higher rigidity can be achieved with an additional upper flange 21a. In the case of glued steel beams 20, cross-axially symmetrical shapes, such as a symmetrical H-profile, can also be installed. In the embodiment shown, the internal bearing means 8 contains, as a reinforcement, conventional reinforcing steels, which is indicated in FIG. 2 b with the connection reinforcement 12, and, on the other hand, the steel profile beam 20. The space around the steel beam 20 is filled with insulating material. The upper portion of the internal bearing means 8 with the connection reinforcement 12 is cast with cast-in-place concrete, so that a continuous concrete upper slab forms. Obviously, in this embodiment, the internal bearing means 8 also adjoins the concrete layer 4 and insulating layer 3 of the slab with each lateral flank 16, the lateral steel profile surface, and the lateral concrete surface, and thus interrupts its layer construction 3, 4. The above statements apply to the preferred dimensions of width W and height H of this bearing means 8. Of course, a combination of internal reinforced concrete and steel profile bearing means 8 can also be incorporated into the layer composite of a slab.

The concept of the bearing means 8 embedded within the slab and interrupting its layer construction offers a space-optimized and at the same time highly efficient bending reinforcement. Under the best possible use of the intermediate space, which the slab statically increases, it is flexurally stiffened with minimal weight input. The insulating material that loads the intermediate space is comparatively lightweight, while one or more internal bearing means 8, as required, are used at the location at which the reinforcement acts most effectively. The internal bearing means 8 run, so to speak, as highly effective “reinforcing ribs” through the slab, regardless of spatial architectural peculiarities, which would have to be taken into consideration for the arrangement of conventional bearing means. Thanks to the very targeted reinforcement, the rigidity and load-bearing capacity of the slab can be decisively increased, with comparatively low use of steel and concrete. The proportion by weight of an optimized wood-concrete composite slab according to the invention, which is allocated to the internal bearing means 8, is only approximately 10% of the slab weight or even less. The weight savings compared to a comparable concrete slab is about 30% with the slab according to the invention, which is considerable. A 50% extension of the span of the wood-concrete composite slab according to the invention to a total length of 9 m, with an increase in weight of the slab equal to or even less than 10%, or even 5-7%, can easily be realized.

Because, with this slab construction, compared to planar wood-concrete composite slabs according to the prior art, a larger spanned dimension can be achieved with a comparatively substantially lower inherent weight, this opens up possibilities for a slab conceptualization of increased area coverage up to inter-story coverage. Specifically, in the case of such slab planning, it is possible to save on load-bearing components which extend through spaces—primarily load-bearing walls—which permanently fix the geometry of a slab plan. The slab system according to the invention thus offers a large repurposing potential for a building, which takes into account the ever faster changing usage needs. Apart from economic efficiency, it has a very positive effect on the sustainability balance of a building, if it can be used in many ways over time without a large amount of remodeling.

It goes without saying that the advantages offered by this slab system are becoming even more important in large-sized buildings. However—especially in large buildings with different building parts and/or numerous separate use units—typically for residential or office purposes—there is another reason—apart from static problems—to install the wood-concrete composite slabs spanning such units with a planar wood element. This is due to sound protection, on which high demands are placed for the non-industrial use of a building. In principle, the higher the standard of an apartment building, the higher the sound protection requirements also are.

Consequently, lightweight components are better than heavy ones for exciting oscillations and transmitting sound. Planar wood-concrete composite slabs with a lightweight wood layer 1 exposed to the room interior, which thus propagates sound well, thus have a difficult starting position. Therefore, in conventional wood-concrete composite slabs, the concrete layer 4 is often made thicker than would actually be necessary statically. For the slab according to the invention, the sound protection means an even greater challenge, because the slab achieves the same static aim with even lower weight, and because the comparatively lightweight wood layer 1 is also still at a distance from the concrete layer 4 and can thus oscillate quasi-independently.

In one embodiment of the slab according to the invention, this problem is addressed by the intermediate layer 3 being filled with at least two layers, i.e., multi-layered, with different insulating materials. For this purpose, the insulating layer 3 has a lower layer 3a with comparatively heavy or dense insulating material. In this way, additional mass can be introduced on and over the wood layer 1 in a concentrated manner in order to load it and thus to make it sufficiently unresponsive to vibration. The remaining space of the intermediate layer is filled with a light or less dense insulating material. The quantitative ratio of these insulating materials can be adapted to the respective sound protection regulations, so that very high requirements, such as are typical for a high-end residential construction standard and in single-family houses, can also be met. In this way, slabs that are comprehensive and usable for a variety of spaces and categories of use can be achieved, whereas conventional wood-concrete composite slabs have to break over partition walls of apartments or office units or other separate units of other use or building parts in order to inhibit the transmission of sound.

Therefore, in a preferred variant of the slab according to the invention, a comparatively dense or heavy insulating material is provided, to work together with a less dense or light insulating material. For this purpose, the wood layer 1 spaced apart from the concrete upper slab by an intermediate space is specifically tasked with lowering the susceptibility of the slab to vibration.

FIG. 3 shows an embodiment of the wood-concrete composite slab according to the invention in cross-section through its layer construction. From bottom to top, first the wood layer 1 is seen, and then an insulating layer 3a made of a comparatively dense/heavy insulating material directly loaded thereon. The wood layer 1 can thus be loaded in a concentrated manner. In a preferred embodiment, an insulating material of such a density or specific weight is selected for the lower insulating layer 3a such that it only takes up a proportion of, at most, half of the intermediate space for the loading of the slab or wood layer related specifically to sound, and advantageously even less than half of the intermediate space—for example, only a fraction, as can be seen here from FIG. 3. An insulating layer 3b of a less dense or light insulating material follows on top of the lower insulating layer 3a and is ultimately covered by the concrete layer 4. In the case of more than two layers, the same are arranged with decreasing weight from bottom to top, because it is primarily the wood layer 1 that is to be loaded therewith. In the case of more than two layers, the density or the specific weight of their insulating materials will increase in the direction of the wood layer 1. This is intended to bring about a targeted loading of the wood layer 1 in order to make it sufficiently vibration-resistant. In this way, higher sound protection requirements can ultimately be met with a comparatively lighter overall weight of the slab than would be the case with an undifferentiated weight input in the intermediate space.

A bulk material is eminently suitable as insulating material. For example, concrete granulate made of crushed concrete or mixed granules of crushed concrete and masonry are recommended for the bottom layer 3a. Such granules can be produced 100% from recycled building substance, which is why it is referred to as recycling concrete granulate or recycling mixed granulate. Filling or lean concrete—preferably made of such granules—also comes into consideration as insulating material for the sound-protection-specific loading of the wood layer 1. A lightweight building material proves to be suitable for the insulating material of the upper insulating layer 3b, e.g., in the form of a bulk material, such as, for example, foam glass gravel, which is produced from pure waste glass. Recycled construction material enters into the environmental impact of a building to an, at most, negligible degree, which is why such insulating material is very preferred.

Furthermore, air can also be used expediently as a lightest insulating material in general for the uppermost layer 3a of the at least two-layer insulating layer 3. The concrete layer 4 that comes to rest over a cavity 3b thus formed must then be supported at the bottom on a permanent concrete formwork 2.

Advantageously, the insulating materials of the at least two-layer insulating layer 3 have very different material densities. The wood layer 1 is thereby loaded in a manner all the more concentrated and thus more targeted, while the remaining intermediate space is not of particular consequence. With selection of a comparatively heavy insulating layer made of recycled concrete granulate applied to the upper side of the wood [density: approx. 1.3 to 2.0 t/m³], and over this a significantly lighter insulating layer made of foam glass gravel [density: approx. 0.2 to 0.3 t/m³], the slab according to the invention significantly saves upon intrinsic weight per unit of slab area while meeting sound protection requirements. The difference in the densities or specific weights of the two selected insulating materials is preferably approximately 0.5 to 2 t/m³. The layers 3a, 3b of the insulation are then introduced in a corresponding space ratio in the intermediate space 3, with the heavy layer 3a on the bottom. Very good values for the acoustic separation of spatial units and stories result when there is a contact pressure of the heavy insulating material of between about 0.7 and 1.4 kN per m² of slab area and of between about 0.1 and 0.4 kN per m² of slab area for the lightweight insulating material. A contact pressure of approximately 0.9 kN per m² of slab area for the heavy insulating material and of approximately 0.25 kN per m² of slab area for the lightweight insulating material offers a good slab weight/acoustics ratio, depending upon the specific circumstances. In any case, the space filled in by the multi-layer insulating layer 3 has an effect on the weight balance of the slab such that it still fulfills the task of an increased span, yet with minimal weight increase, and thereby achieves high sound insulation values. With its sound-protection specific loading, it can individually meet the respective specifications for the sound insulating mass.

As shown in FIG. 3, one or more impact sound insulating panels 22, the subslab 23, and, where applicable, a slab covering, typically follow on top in the final stage on the concrete upper slab. The cutout shown here does not have an internal bearing means 8. It goes without saying that such a bearing means 8, or a plurality of such, can be accommodated in the same way in the raised portion next to the insulation, as was shown in the preceding FIGS. 2 a and 2 b. The insulating layer 3 is then advantageously structurally interrupted only by one or by the plurality of any internal bearing means 8, apart from connection-related interruptions in the insulating layer 3, as will be explained later. This type of slab loading with multi-layer insulating layers 3a, 3b is used where the acoustic separation provides this. In any case, the slab according to the invention can also manage, in an acoustically optimized variant with an at least two-layer insulating layer 3, without an internal bearing means arrangement. In this case, the insulating layers 3a, 3b extend over the entire spanned dimension of the composite slab without being interrupted by support structures. Such an embodiment of the slab according to the invention can be used when sufficient flexural rigidity of the slab is ensured solely by the spacing of the wood layer 1 from the concrete layer 4 that is secured in a shear-resistant manner. The production of such a slab with an at least two-layer insulating layer 3 will be discussed later.

A further key to increasing the rigidity and load-bearing capacity of a wood-concrete composite slab consists in the connection of wooden panels combining to form a planar wood element 1. While the concrete upper slab together with its reinforcement 15 is always designed for two-axis support, the wood layer 1—at least according to the prior art—bears the slab as a whole only in one direction. It is indeed the case that the wood-based materials used in wood-concrete composite slabs are usually layered crosswise. Wooden panels made of wood materials layered in such dimensions can thus be load-bearing on two axes. In practice, however, the wood layer 1 of a slab with typical spans usually cannot be produced as a single, continuously veneered panel. Rather, this wood layer 1 is then composed of a plurality of wooden panels, wherein each slab element consists, for reasons of simplicity, of a single veneered wooden panel and the concrete upper slab 4 situated over it or the composite layers 3, 4. However, in order for a large-area wood layer 1 formed by a plurality of subsequent slab element wooden panels to now be able to bear loads continuously on two axes, a tensile force connection of the individual wooden panels is required. In one embodiment, the wood-concrete composite slab according to the invention therefore provides an intimate tensioning of wooden panels load-bearing on two axes. Overall, a very high load-bearing capacity of the slab can thus be achieved without additional weight—especially because the weight of the connecting elements or tensioning means is negligible.

In a preferred embodiment of the wood-concrete composite slab, the latter includes at least two abutting wooden panels, which are tensioned against one another by tensile force with the connection systems presented below. For this purpose, at least one recess 24 is cut or milled out in each case in the wooden panels—leaving intact their undersides above the same—in such a way that, first, they form at least one box-shaped space for accommodating a tensioning means 26a, 26b, 26c, and, secondly, these recesses 24, in the abutting position of the panels, form a continuous recess 25 or a passage spanning across the wooden panels. Behind their rearmost box-shaped space 24, the wooden panels are in each case intact, i.e., they are not drilled, screwed, etc., for this purpose, and there form rear intact material 29 that can be used there in another way. This creates favorable space conditions in the wood layer 1. Primarily during the attachment of shear connecting means 6, whether steel pipes, adhesive, or other wood-concrete connecting elements 6 introduced into grooves or channels 7 of the wood layer 1, it proves to be advantageous to be able to use the wood layer 1 in as comprehensively intact a state as possible for this purpose. The end face 28b of the rear intact material 29 of the wooden panel can also remain free in any case of anchoring for the tensioning means 26a, 26b, 26c—for example, also by adhesives. The tensioning means 26a, 26b, 26c of the connection system is inserted and mounted in the passage formed by the recesses 24 in the abutting layer. The tensioning means 26a, 26b, 26c is in each case anchored at the end in the rearmost box-shaped space 24, 24a of the wooden panel, so that, when the tensioning means 26a, 26b, 26c is subjected to tensile stress, the wooden panels anchored thereto are pulled against one another and thus tensioned together. Tensile forces can be effectively conveyed through a connection formed from at least two wooden panels pressed together in this way. This creates the two-axis load-bearing capacity of the wooden panels thus connected to a continuous planar wood element 1. A plurality of such recesses 24 is typically arranged at regular intervals along the abutment axis in the wooden panels.

The wooden panels advantageously have identically dimensioned and arranged recesses 24. Then, wooden panels having the same recesses 24 at the same location can be prefabricated, so that, when a connection is produced, there is generally no need to pay attention to a specific side. Thus, each prefabricated wooden panel can be located on the near side or on the remote side of the abutment axis. A recess 24 can also be formed from a plurality of smaller box-shaped spaces 24a, 24c and their continuous connections 24b, as will also be presented later. In a preferred variant of the connection system, the tensioning means 26a, 26b, 26c need to be inserted only loosely into the recesses 24. For the tensioning, the tensioning means 26a, 26b, 26c then does not need to be either screwed, doweled, glued, or otherwise secured to the wooden panels by engagement with the wood. Rather, the wooden panels can be left intact except for the recesses 24, which are required for the tensioning. This variant is therefore particularly simple to realize quickly and, especially, extremely easy to install. In the event of faults when mounting the tensioning means 26a, 26b, 26c, the wood cannot be irreversibly damaged. In a further preferred embodiment, the components 26a, 26b, 26c of the tensioning means are joined together to form a symmetrical arrangement, which further simplifies the connection system.

However, how the positive locking of the wooden panels in the abutting layer is formed in detail is irrelevant. In a tongue-and-groove design, an end face of the wooden panel is advantageously provided with a tongue which tapers at an acute angle up to an obtuse angle, and the end face of the other wooden panel is provided with a groove which correspondingly narrows in the depth, so that the wooden panels can be pushed well against one another and are then aligned with one another in an accurately fitting manner. Otherwise, the end faces of the wooden panels to be tensioned can also be designed flat and join together to form a butt joint. All of the embodiments of the connection system presented here can be achieved on wood-concrete composite slabs having a planar wood element 1 with or without insulating layer 3, and thus also on wood-concrete composite slabs according to the prior art.

A specific embodiment with a symmetrical tensioning arrangement is explained on the basis of the wooden panel longitudinal section according to FIG. 4 a to 4 c. First of all, a single wooden panel having an already inserted anchor can be seen in FIG. 4 a. The wooden panel has a special recess 24. It consists of a rear and a front box-shaped space or chamber 24a, 24c and a hollow channel 24b which connects these chambers 24a, 24c. Behind the rearmost chamber 24a, the wooden panel is intact and is referred to there as the rear intact material 29, while the hollow channel 24b runs in the front intact material 27, which is intact except for this hollow channel 24b. Both chambers 24a, 24c are open towards the top, and the front chamber 24c is additionally open at the end face. The anchoring can thus be conveniently installed. A screw head 26a is loosely inserted into the rear chamber 24a and screwed to a threaded rod 26b which has been guided through the hollow channel 24b into the rear chamber 24a. Due to the dimensioning, the screw head 26a does not fit into the hollow channel 24b. It can thus be moved at most to the rear end face 28a of the front intact material 27 and abuts it, whereby it acts as a tensioning block 26a.

In FIG. 4 b, two such wooden panels are pushed together in a positive-locking manner, as shown by the dashed separating line. The abutment axis runs in the sheet plane. Because the front chambers 24c are open on the end face, they form a common chamber 25 that is open towards the top in the abutting position. Finally, all chambers 24a, 24c are connected by this common chamber 25 in a manner spanning across panels or continuously. A tensioning means—in the example shown, a sleeve 26c—is inserted loosely into the common chamber 25. Because the screw head 26a has play within the rear chamber 24a, it can be pushed to the rear far enough that space is created at the front in the common chamber 25, in order to screw the threaded rods 26b exiting the hollow channel 24b into the sleeve 26c. The threads of the two threaded rods 26b are opposite by design. The sleeve 26c into which it is screwed therefore has a counterclockwise internal thread, and on its opposite side a clockwise internal thread. If the sleeve 26c is then rotated in the fixed location, this pulls the threaded rods 26b uniformly on both sides, until the screw heads 26a abut against the rear end faces 28a of the front intact material 27 in the rear chambers 24a.

With a further rotation of the sleeve 26c in the fixed location, a strong tensioning of the two wooden panels is achieved, as shown in FIG. 4 c. The screw heads 26a are each pressed against the rear end faces 28a of the front intact material 27 and thus act as tensioning blocks. This tensioning system 26a, 26b, 26c can obviously be used in a side-independent manner. Advantageously, the threaded rods 26b together with the screw heads 26a are installed in the factory, as shown in FIG. 4a, and then only have to be pulled together with the sleeve 26c at the construction site. A coupling including a central nut and two threaded pipe sections which can be pulled together by said nut can be used instead of a sleeve 26c with two opposite threads, wherein the threaded rods have the same thread directions of rotation for this purpose. The mechanically contrasting connection system also functions with a sleeve nipple connection. Instead of the sleeve 26c, it is then a nipple with opposite threads which is rotated in the common chamber 25 for the tensioning in the stationary position and thus pulls together two sleeves with corresponding internal threads, instead of the threaded rods 26b. All variants of these threaded connections form with their components 26a, 26b, 26c a symmetrical design with respect to the parting plane of the wooden panels (for which purpose the directions of rotation of the threads are not taken into account). In this case, the tensioning means does not have to be fixedly connected or secured to a wooden panel, e.g., by screwing, doweling, or gluing, etc., of the anchor means 26a. Accordingly, the wooden panels can be tensioned together easily and efficiently. For this purpose, they are prefabricated identically and can easily be exchanged for the installation of the connection system.

A tensioning lock with tensioning lever 26c, as shown in FIG. 4 d, is also suitable as tensioning means 26a, 26b, 26c. Each wooden panel is cut out in such a way that it has a box-shaped space, open at the top and partially open at the end face, as the only recess 24, wherein the front intact material 27 extends to the parting plane. Behind these recesses 24, the wooden panels are intact, as can be seen in the rear intact material 29 in FIG. 4 d. The recesses 24 can be designed identically, which prevents errors in the prefabrication of the wooden panels. In the abutting position of the wooden panels, a passage spanning across the two wooden panels to be tensioned in the front is in turn formed in the form of a common recess 25, via which the operative connection is created. For this purpose, tensioning blocks 26a with tensioning levers/tensioning hooks fastened thereto are loosely inserted in the chambers 24. The tensioning arm 26b hinged here at the right tensioning block 26a is placed around the tensioning hook of the left tensioning block 26a opposite it, whereby the tensioning means is anchored on both sides in the chambers 24, and thus without the anchors having to be firmly connected to the wooden panels. By pivoting the tensioning lever 26c, the tensioning arm 26b is pulled to the right, which presses the tensioning blocks 26a against the front intact material 27 and fully tensions the wooden panels against one another. Although the tensioning lock is not designed to be symmetrical here, it can be used independently of the side. Of course, a double-sided tensioning lever closure designed symmetrically to the parting plane can also be used. Instead of a tensioning lever with tensioning arm, a thread design with hooks or handles articulated on both sides can be used, which hooks or handles engage on the two tensioning blocks 26a—for example, around a cam, bolt, or the like integrally molded there. As an example of this, a tension spindle with threaded rods 26b and hexagonal sleeve 26c running thereon is shown in FIG. 4 e.

It will be understood that the present figures are only schematic representations. In the real case, the front intact material 27, against which the anchorings 26a apply pressure directly, is designed to be very much longer or deeper, e.g., 0.2 to 0.5 m long or more, and thus dimensioned to be far longer than the tensioning blocks 26a. The contrasting connection system thus engages over a long or deep range of the wooden panels and withstands a strong tensioning. Depending upon the length or articulation of the tensioning arm 26b, it can also be guided through a hollow channel 24b, which is bored through the front intact material 27, in order to grip against the tensioning block 26a of the adjacent abutting panel. FIG. 4 f shows a hollow channel 24b of this type in the image on the right side, in which one looks towards the front intact material 27 in the direction of the abutment axis towards the parting plane of the wooden panels. However, in the case of a symmetrical tensioning fastener such as a tension spindle, at least at the location of the force transmission or at the location of its sleeve 26c, the passage must be open, i.e., must be accessible for the tensioning. For this purpose, the embodiments with a U-shaped or rectangular cutout in the front intact material 27 or else recesses 24 as shown schematically in FIG. 4 a to 4 c are suitable.

In an alternative embodiment of the tensioning fastener, the tensioning blocks 26a are each fixedly connected—for example, glued or, as in the example according to FIG. 4g, screwed—to a wooden panel. Depending upon the embodiment, the anchoring is attached only to the slab and/or the side walls of the box-shaped space or the recess 24. This is shown with two examples in the cutouts of a cross-section through the recess 24 parallel to the parting plane according to FIG. 4 h. In the right image, the tensioning block 26a is U-shaped and can be anchored laterally out of its interior in the recess 24. In principle, the tensioning block 26a can be anchored in both embodiments laterally and towards the bottom, which is expedient, depending upon the spatial conditions. These fixed anchors keep the detrimental impact on the wood comparatively low and leave the end face 28b of the rear intact material 29 always free of anchoring means. In the case of tensioning blocks 26a anchored only at the bottom of the recesses 24, all side walls of the rearmost of the recesses 24, or in this case the only one, remain free of anchoring means. Behind these recesses 24, the wooden panels are intact. They can in turn be produced identically. The tensioning lock to be fixedly anchored is also usable in a side-independent manner and can also be realized symmetrically, analogously to what was outlined above.

In a further variant, a tensioning of the wooden panels can be realized by means of a tensioning wedge 26c and a counter-wedge 26a, as shown in FIG. 4 i. The wedges 26a, 26c are arranged within the same box-shaped recess 24 of a wooden panel, seen in FIG. 4 i on the right. As a result of the tensioning wedge 26c being knocked down or knocked in or clamped, the counter wedge 26a moves translationally to the right and pulls a threaded rod 26b which is anchored in a tensioning block 26a in the opposite box-shaped recess 24 of the remote-side wooden panel, and anchored with the counter wedge 26a in the near-side wooden panel. The front intact material 27 on each of the wooden panels is pressed against the other by the tensioning block 26a and by the wedges 26a, 26c acting as tensioning blocks, which tensions the wooden panels tightly against one another. This wedge connection can also be used independently of the side. The tensioning wedge 26c has a preferably U-shaped recess at the bottom, with which it is slipped over the threaded rod 26b. This wedge shape is shown in FIG. 4 j. In a shorter embodiment of the tensioning wedge 26c, it does not reach to the threaded rod 26b even in the fully tensioned state. FIG. 4 k shows a symmetrical variant of the wedge tensioning with a tensioning wedge 26c and a counter wedge 26a in a box-shaped recess 24. For all variants of the tensioning presented, the recesses 24 can be cut out identically in the wooden panels. Behind the box-shaped recesses 24, the wooden panels remain intact and can be used there, for example, for the insertion of shear connectors 6, 9.

With the production of the wood-concrete composite slabs according to the invention, a high degree of industrial prefabrication can be achieved, because the slab can be prefabricated in a modular design and then be assembled in place at the construction site. Above all, this increases construction and assembly efficiency during the production of slabs with large spanned dimensions. Such a method for producing the slab according to the invention is described in detail below.

For a single slab module, the bottommost slab layer—the wood layer 1—is first processed. This is typically veneered as a single seamless wooden panel. At the location of the shear connectors 9 to be inserted, the recesses 30 explained at the outset were cut or milled into the wood layer 1, as can be seen in FIG. 5 a. In the variant shown here, steel tubes 9 were glued in, wherein the epoxide adhesive that swells out is shown annularly around their circumference. A formwork 31 lined with a film 32, encloses the wood subslab 1 along its edge region. In addition, bulges of the film 32 can be seen along the side regions of the formwork 31 at regular intervals. Among these are placeholders 33, e.g., made of rigid polystyrene foam, the space of which is thus kept free during the subsequent application of material in order to be able to later frictionally connect the slab module.

In FIG. 5 b, three rows of shear connectors 9 are placed on the wood layer 1 and connected thereto. Here, the formwork 31 is partially covered, whereby the view of the placeholders 33 becomes clear. The film 32 is laid around the formwork 31 and glued to the wood slab 1 at the bottom in order to laterally seal the subsequent material application. Any connections and components, such as building technology elements, are installed directly on the wood layer 1.

In FIG. 5 c, the upper side of the bottommost slab layer or the wood layer 1 is again seen, but without formwork 31 in this view. A sprinkler system 34 was installed on this upper side, as is customary for fire protection in buildings which are not exactly used as museums, libraries, and repositories with irreplaceable objects to be protected from water penetration. Likewise recognizable are the front recesses 24c, which are cut or milled into the wood layer 1 in this preferred slab design and are regularly distributed in this case over the longitudinal side of the wood layer 1 for their subsequent connection and tensioning with the wood layer 1 of a module adjoining laterally thereto. The rear recesses 24a, which are covered here by wood blocks, are located behind it so that the insulating material to be filled into it cannot penetrate into and thus clog it. These can also be prevented, for example, with film coverage. In any case, the tensioning of the wood layers 1 of the individual modules relates only to a preferred embodiment of the invention if the wood layers 1 are to be designed to bear loads continuously on two axes.

In order for the slab module to be lifted by a crane after its completion, an anchoring of the load-handling attachment 44 in the wood layer 1 is advantageously applied. In the case of lifting belts 44, tensioning blocks—preferably slightly chamfered—that are anchored in the wood layer 1, for example, and tension the belts 44 with the surface of the wood layer 1 are suitable. If an anchoring of load-handling attachments 44 in the slab element is dispensed with, the finished element can instead be raised, for example, using the same wraparound lifting belts.

FIG. 5 d shows the next method step, in which the insulating material for constructing the insulating layer 3 is filled in or poured in, etc., over the wood layer 1. In the present embodiment, cellulose fibers are blown in as insulating material, whereby they form a compact mass. The cellulose fibers, which can be seen on both sides along the module, here cover the shear connectors 9 protruding from the insulating layer 3. The film 32 was laid in the formwork 31 such that it can surround the insulating layer 3 over its edge regions. A multi-layer insulating layer 3 is also filled or poured, blown in, etc., in this way—preferably with a separating film 36 between the individual material layers. For a two-layer insulating layer 3, for example, a lower layer of concrete granulate and, above this, a lighter layer of foam glass gravel—preferably in a ratio of their heights of between 1:1 and 1:4 from heavier to lighter insulating layers—are suitable as insulating layers. As shown in FIG. 5 d, measuring rods 43 are advantageously used in order to ensure the proper height of the insulating layer 3. Through the columns of the auxiliary frame 37 for the formwork 31 can be seen a portion of the wood layer 1 which is not enclosed by the formwork 31 and is thus excluded from the insulating layer 3 and the concrete layer 4 to be applied later. This part of the wood layer 1 forms a contact surface 35 for an internal bearing means 8 later on and over the wood layer 1.

After the insulating layer 3 has been completely applied, the flaps of the film 32 are folded inwards so that the insulating layer 3 is surrounded by the film 32 all around its side surfaces. In addition, a layer release film 36 is placed over the upper insulating layer so that the fresh concrete to be introduced subsequently does not infiltrate the insulating layer 3. Openings are cut into the separating film 36, from which openings the upper ends of the shear connectors 9 can exit, and, in the case of anchored load-handling attachments 44, can exit said openings in guides 45, as can be seen in FIG. 5 e. The ends of the shear connectors 9 thus protrude into the next concrete layer 4 to be applied, with which they then intimately connect. First, however, the reinforcement 15 is inserted for the concrete layer 4, with a conventional multi-layer—in this case, two-layer—typically also four-layer—arrangement of the reinforcement rods in a lattice structure. In FIG. 5 e, the placeholders 33 on the left inner side of the insulating layer 3 can also be clearly seen on the formwork 31. These regions are thus excluded for the subsequent application of concrete.

The concreting process is shown in FIG. 5 f. In this case, the fresh concrete is already poured into the formwork 31 and is in particular vibrated in, as a result of which it settles on the insulating layer 3 (no longer visible here) as a compact, level upper layer 4. The upper ends of the shear connectors 9 are now also completely covered by the concrete layer 4 and therefore are no longer visible. Here, the placeholders 33 are exposed in places. The guides 45 for the load-handling attachments 44 project at the top from the concrete layer 4. After curing of the concrete layer 4, the formwork 31 is removed, and the inserted placeholders 33 are detached or poked out. The slab module is thus completely created and ready for assembly.

FIG. 5 g shows two such slab modules on supports 38, as they are typically stacked for transport. The modules are created in a road-transportable size so that they can be moved to the construction site and can be assembled there to form a wood-concrete composite slab. It can be seen how the insulating layer 3 is surrounded by the film 32 all around its side surfaces and is thus retained. It can be seen that projections of the wood layer 1 of the modules that protrude below the composite are also formed, which form open surfaces 35 at the top. These are filled with fresh concrete poured in place, as will be explained below.

FIG. 5 h shows how a single slab module is raised on the lifting belts 44 with a crane device in order to place it in the position predetermined for it. Provided as a support/as supports is/are either vertically installed vertical components of the support structure, such as columns 18 or load-bearing walls, and/or temporary slab supports—for example, in the form of braces. These are removed again after the slab has been completely created. In the module shown, recesses 39 are arranged in both longitudinal sides at regular intervals, viz., where placeholders 33 were previously located. Accordingly, these locations are free of concrete, or, above the wood recesses 24c, are free of insulating material and concrete. Thanks to the excluded recesses 39, this module can be frictionally connected to an adjacent module on each longitudinal side. It is understood that modules to be laid end-to-end do not have any recesses 39 at their end sides. Depending upon the intended frictional connection, the module sides can be provided with such recesses 39, for one-, two-, three-, or four-sided tensioning of the corresponding module with adjacent elements.

In FIG. 5 i, a portion of the resulting slab made up of a plurality of abutting modules is shown. The lifting belts 44 for the crane transport in part have not yet been removed. The recesses 39 of adjacent elements come to rest opposite one another and together with them form a common recess 40—in some cases only in the concrete layer 1, but in this case also through the insulating layer 3—as a result of which the recesses 24c which are likewise joined together to form a common recess 25 are accessible from above for the tensioning of the module wood layers 1. The tensioning means 26a, 26b, 26c are then tensioned in the recesses 25 of the wood layers 1, and the cavity is filled with insulating material as far as the lower edge of the respectively adjacent module concrete layers 4. This is advantageous in any case, because an effort is made to install as little concrete as possible on-site. Except for the interruptions required by the bearing means, the insulating layer 3 is realized in a modular manner as a continuous slab layer. The reinforcement 15 is then inserted and connected to that of the adjacent modules. In FIG. 5 i, an exposed contact point 35 is clearly visible on a wood layer 1, which, after one or more further modules have been connected thereto, forms an intermediate space 41 or delimits it at the bottom. This is later poured into an internal bearing means 8. The module group shown here already includes two intermediate spaces 41 running perpendicular to one another over their wood layers 1. It can be seen that the insulating and concrete layers 3, 4 are continuously spaced apart from one another along these intermediate spaces 41.

The bearing means reinforcement 42 is installed in these initially free intermediate spaces 41. An image as shown in FIG. 5 j results. Furthermore, the reinforcement rods 15 exiting from the concrete layers 4 can also be seen in the recesses 40. Such a recess 40 is shown separately in FIG. 5 k, after the adjacent concrete reinforcement 15 have been fully installed, for their frictional connection. FIG. 5 l shows a typical bearing means reinforcement 42 with its tensile and compressive reinforcement 10, 11 as a longitudinal reinforcement, wherein, in this plan view, above all, the compressive reinforcement 11 can be seen. The longitudinal reinforcement 10, 11 is enclosed by a stirrup reinforcement 13. The connection reinforcement 12 is formed from bent reinforcement rods and is here inserted horizontally, alternatively to the embodiment according to FIG. 2 a, for reasons of space. This connection reinforcement 12 is connected frictionally via a bell butt joint 14 to reinforcement rods 15 exiting from the concrete layer 4. Not evident in the image are the wood-concrete connection means 6—in this case wood construction screws 6—which have been introduced into the wood layer 1, in order then to create an intimate connection of the internal bearing means 8 to be cast with the wood subslab 1. Meanwhile, in one embodiment of the internal bearing means 8 with a steel beam profile 20, the same is inserted into the intermediate space 41 and is frictionally connected to the wood layer 1. The still remaining space is then filled with insulating material until, at the top, the same adjoins flush with the lower edge of the adjacent concrete layers 4. A reinforcement with a connection reinforcement 12 is then placed in the remaining space 41, to be cast with concrete, between the adjacent concrete layers 4 and is connected frictionally to their reinforcement 15.

The intermediate spaces 41, which have been completely reinforced, are filled with concrete 48 and smoothed—the recesses 40 likewise, as is done in particular in FIG. 5 m. If no insulating material is arranged in the recesses 40 that reach as far as the wood layer 1, the recesses are then completely filled with cast-in-place concrete 48. However, this is rather atypical, because the final casting with fresh concrete 48 is kept as low as possible. However, in the case of concrete interruptions required for connection, the insulating layer 3 of the slab would be assembled quasi-continuously over the modules. An internal bearing means 8 is freshly created here, as can be seen on the still-wet concrete 48. In addition, the recesses 40 still to be concreted are shown schematically. With curing of the fresh concrete 48, the wood-concrete composite slab is created to be load-bearing with a planar wood element.

In any case, the modular production method of the slab according to the invention represents an innovative, time-saving, and cost-effective method. Due to the high degree of prefabrication, these advantages result, whereby a large-area composite slab can be assembled very efficiently. The internal bearing means 8 were created exclusively on-site here, which, however, will not always be the case. In the case of embodiments of the internal bearing means 8 which project towards the bottom, it proves to be expedient to use prefabricated bearing means components 49. Only the final casting of the bearing means 8 remains to be carried out in cast-in-place concrete 48, as explained later.

In other embodiments of the slab according to the invention without internal bearing means 8, the method steps associated therewith are simply omitted. For example, in one variant, the wood-concrete composite slab according to the invention can be produced in a modular manner from at least two slab modules as a composite slab that is highly sound-protected, but free of bearing means. For their layer construction, from bottom to top, first, the wood layer 1 is in each case produced, including the shear connectors 9 anchored therein with their lower ends. The insulating layer 3 is then formed with at least two layers 3a, 3b, in that a comparatively denser insulating material is introduced for the lower layer 3a, in order to introduce concentrated mass on and over the wood layer 1, with which it is loaded and consequently vibration-resistant. A comparatively less dense insulating material is introduced for the at least one upper layer 3b. Finally, the concrete layer 4 is also applied with its reinforcement 15, so that the shear connectors 9, which penetrate the insulating layer 3, are anchored with their upper ends in the concrete layer 4. Because in this embodiment the modules are not frictionally connected via an internal bearing means 8, recesses 39 are provided in the concrete layer 4 of at least one module, from which recesses the reinforcement 15 exits in order to be frictionally connected to the reinforcement 15 of the adjacent concrete layer 4. These recesses 39 are then also concreted. It goes without saying that, accordingly, the wood layers 1 of the modules can also be frictionally tensioned against one another. Recesses 39 are then not provided solely in the concrete layer 4, but also in the insulating layer 3, so that the wood layers 1 to be tensioned are accessible from above for their tensioning. The completely created slab module is then laid in the position predetermined for it on one or more supports and is connected to the at least second slab module as described, and the recesses 39 are concreted. The production method for a wood-concrete composite slab which is acoustically optimized in this way is characterized by high construction and assembly efficiency. A slab with large spans can be created in principle in few steps by such modules.

Regardless of their disadvantages, conventional wood-concrete composite slabs also offer good load-bearing reliability. For the following considerations, a distinction is made between the normal case and the case of fire. For the normal case, a regular building operation is assumed, with its different combinations of main, additional, and special loads measured as to the probabilities of their occurrence, their duration, etc. With the dimensions of conventional wood-concrete composite slabs, in normal cases, comfortable static reserves are achieved which are sufficient even in the event of a fire if the combustible wood layer 1 is impaired. On the one hand, such wood-concrete composite slabs are of benefit in that they are mostly designed from softwoods such as spruce wood and therefore have to have a considerable thickness for reasons of statics. For this reason alone, these wood layers 1 will not fail immediately in the event of a fire. In addition, wood is decomposed during the combustion process with the formation of charcoal and flammable gases, wherein the carbon layer thus formed forms a very good insulator due to the significantly lower thermal conductivity compared to wood. The inner wood is thus protected for a long time from the effect of heat, so that a thick wood layer 1 still provides a sufficient static contribution even in the event of a fire. However, a slender slab system results in a disadvantage here.

First of all, sufficient fire protection requires that the support structure of a building remain safe against collapse at least as long as is necessary for its complete evacuation. The evacuation duration is calculated according to the building structure—in particular, the design and dimensioning of the escape routes—and is all the longer as the number of stories in a building increases. In addition, components are classified in terms of fire protection—usually according to a load-bearing and/or fire-compartment-forming function. A distinction is also made between linear and planar components. In view of this, the building is then fitted with higher or deeper supports. Only because the wood layer 1 of a wood-concrete composite slab is a combustible planar, load-bearing component is it often criticized as such in terms of fire-protection technology—even though its static performance would basically be sufficient even in the event of afire. This can usually be remedied by elaborate measures in escape route planning and dimensioning and/or a fire-resistant cladding of the wood layer with, for example, gypsum board panels, etc. The result of this is that, precisely in buildings which are regularly covered by high fire protection requirements due to their position, number of stories, and extension, the use of a wood-concrete composite slab with a planar wood element is not appropriate or does not pay off, despite significant advantages.

However, the slab system according to the invention can also be used to tap into such previously unused fields of application. The circumstance can be used that the number of occupants in a building tends towards zero during the evacuation. Accordingly, a support structure affected by fire has to be able to bear only around 50-60% of the maximum load, and also not continuously, but only until evacuation is complete. The wood-concrete composite slab according to the invention can satisfy this condition thanks to its internal bearing means concept, in such a way that the supporting wood layer 1 is not subject to the requirements of a planar, load-bearing component; the non-combustible slab support structure or the residual support structure made of a concrete layer 4 and internal bearing means 8 can completely compensate for the absence of the combustible wood layer 1, so that the wood layer 1 does not have to make a static contribution for the critical period of time. Whereas, in the event of a fire, a conventional planar wood-concrete composite slab, i.e., a load-bearing planar component which as a whole is indispensable, would have been damaged, the wood-concrete composite slab according to the invention would only involve a component that, by comparison, is statically expendable anyway. This leads in particular to the fact that the wood layer 1 can remain unclad and thus can remain visible and distinctive despite requirements for planar load-bearing components. An exception is constituted by escape routes with special requirements beyond the static expendability. In any case, however, the internal bearing means 8 create advantageous conditions, so that in principle fewer or lower fire protection measures have to be provided for a building.

FIG. 6 shows a schematic support structure concept based upon a slab plan for a multi-story building or high-rise building with the use of a wood-concrete composite slab according to the invention. A reinforcing, load-bearing building core 17, in which, for example, elevators and/or a stairwell are accommodated, forms with its load-bearing walls a support for the slab adjacent thereto, just like the vertical support columns 18 arranged along the façade 19 and in the interior of the buildings. As can be seen, the slab spans the entire region between the core 17 and the façade 19, and spans substantial dimensions. At the same time, with the exception of the building core 17, no load-bearing walls are found inside the building. This is due to the intelligent arrangement of internal bearing means 8, which leave the space as unobstructed as possible, because, in the building interior, they manage with only just two columns 18 as point supports, while they share the columns 18 of the façade 19 as outer supports and the core 17 as corner supports. In this case, as explained at the outset, the internal bearing means 8 can be made completely of reinforced concrete or else with a steel profile 20, or these variants are combined with one another. In the present embodiment of the slab according to the invention, the internal bearing means 8 can be divided into two categories. In the slab plan longitudinal direction (horizontal direction in FIG. 6), the primary internal bearing means 8a are each located with one end supported on the building core 17 and the other end on the façade columns 18. These are referred to as such because they are always—i.e., both in the normal case and in the event of a fire—indispensable in the support structure geometry selected here. With the core 17 and façade 19, they delimit four large slab areas. Transverse thereto, i.e., running in the vertical direction in FIG. 6, the secondary internal bearing means 8b, which are hatched, are visible. As their name suggests, they are normally of minor importance, because the slab is able to provide the required load-bearing capability even without their contribution. For the normal case, the support directions of the four large slab areas have been indicated and drawn in distributed over the entire slab: the main support direction of such a large slab area (the support direction with the greatest stress) with a large arrow, and its auxiliary support direction (the support direction with the lesser loading) with a small arrow. The secondary bearing means 8b must be hidden for this purpose, because they normally do not play a decisive or critical role in the load transfer of the slab—the slab supports the present consideration without them.

Only in the event of a fire, if the wood layer 1 is fire-damaged, e.g., due to failure of a sprinkler system 34, must it be possible for the horizontal load absorption and transfer to the vertical supports 18 to be distributed to all bearing means 8a, 8b of the slab. They then all form indispensable components of the residual support structure. It is now decisive that the slab, with the inclusion of all internal bearing means 8a, 8b, is divided into numerous smaller slab areas, because, according to this static analysis, the secondary internal bearing means 8b also act upon the load absorption or the load transfer. Accordingly, new main and secondary support directions of the slab also result in relation to these smaller slab areas, which for reasons of clarity are not specifically shown here. The slab areas supported on the active bearing means 8a, 8b are consequently less, so that the comparatively thin concrete layer 4 can span the story for the relevant evacuation duration in this cassette slab structure of the slab and be safe against collapse. The wood layer 1, or at least the relevant part thereof at risk of fire, can be regarded as static, like a cladding, during this period. Therefore, the wood layer 1 also does not need to be covered in a fire-resistant manner, and instead offers an aesthetic, continuous, and thus uninterrupted, slab soffit in the interior of the story. Of course, the wood layer 1 can nevertheless be plastered on the interior side, or even only in some places if this is desirable, e.g., with regard to the particular aesthetics or if such is generally prescribed—for example, along escape routes. In the present embodiment, the building core 17 also forms the exit route at the same time. In any case, thanks to such an internal bearing means concept with internal bearing means 8b, which normally are statically superfluous, the fire protection requirements for a building can be significantly reduced.

In other embodiments of the slabs according to the invention, internal bearing means 8 can also be conceptualized as a makeshift, static remedy in the event of a fire. The reverse case, with one or more bearing means 8 only as primary bearing means 8, or only as primary internal bearing means 8, is also conceivable if this can be implemented in terms of fire protection. In any case, the rigidity/mass ratio of the slab is optimized with integration of internal bearing means 8 into the support structure to be loaded in a regular manner, its weight is reduced, its height is minimized, and the number of stories in the building that can be realized is maximized, as has already been explained at the outset. The proportion by weight of an optimized wood-concrete composite slab which is dispensed with on the internal bearing means 8, 8a, 8b is only approximately 10% of the slab weight, or even less. The gain in flexural rigidity and associated advantages exceeds this weight amount in several respects. It is therefore advisable to statically distribute the supported load even of the regular building operation on internal bearing means 8, 8a, i.e., to design at least a portion of the internal bearing means 8a as a component of the primary support structure.

The slab plan according to FIG. 6 is to be understood merely as an exemplary embodiment. The dimensioning of the slab—in particular, of the internal bearing means 8—can of course be adapted to the peculiarities of each building. In principle, however, the internal bearing means 8 are distributed in such a way that they follow the force profile of the slab and divide them into sensibly small slab areas. “Sensible” here means that, as much as possible, the accompanying vertical support of the internal bearing means 8 does not impair the interior of the building, and the slab is nevertheless designed with sufficient flexural rigidity for its purposes. The internal bearing means 8 are therefore advantageously supported only on columns 18. The term columns 18 is understood to mean vertically installed components which absorb and convey loads mainly in the direction of their longitudinal axis. These only minimally restrict the space. In any case, a slab plan can be used almost however one wants, because, at most, non-load-bearing walls have to be erected or dismantled.

FIG. 7 illustrates a support configuration with columns 18 which adjoin the slab at the top and bottom in the background. The slab cutout shows the structure as is known from FIG. 2 a, wherein the illustration of the reinforcement has been omitted. However, the wood-concrete connecting elements are shown in the form of wood construction screws 6 used here. Where the lower column 18 meets the slab, the wood layer 1 has a recess so that it is flush with the column 18 on all sides. During assembly, the prefabricated slab modules are placed on a temporary support around the column 18. FIG. 7 shows the separating line of the abutting wood layers 1 of the two slab elements. The internal bearing means 8 is cast on their contact surfaces 35 that are left open and connects monolithically to the lower column 18 at the location of the recess in the wood layer 1. With curing of the cast-in-place concrete 48, this acts as a support for the slab. In addition, an upper column 18 is connected conterminously and extends the vertical support structure into the upper story, for effective conveyance of the acting forces. A plurality of columns 18 are preferably arranged along an internal bearing means 8. A support structure configuration having internal bearing means 8, which are mounted on columns 18 over their length at regular intervals, is the norm. In cooperation with these columns 18, the internal bearing means 8 create a highly efficient support structure grid. The majority of the interior of a building remains free of load-bearing, planar building structures or is only punctuated by columns 18 at certain points.

In some cases, it is advantageous to be able to increase the cross-sections of the internal bearing means, i.e., beyond the height of the slab layer composite, in order to achieve a particularly high bending reinforcement. Possibilities for such an upper or lower projection of an internal bearing means 8 from the composite slab are presented below.

The support configuration according to FIG. 8 is suitable in hollow slabs, i.e., in system slab construction types which include a cavity for accommodating, for example, electrical connections, and telecommunications, sanitary, heating, and ventilation installations, etc. The cavity 46 at the same time creates space for a cross-sectional enlargement of the internal bearing means 8 beyond the concrete layer 4. Such a cross-sectional enlargement can take place either over the entire length of the internal bearing means 8, or only locally—for example, in a limited region above columns 18. The merely local projection proves to be advantageous, because it does not form a continuous barrier for the cable routing in the cavity 46. The internal bearing means 8, after the end removal, remains invisible from the outside. The installation is carried out analogously as described above with respect to FIG. 7, with the difference that, here, additionally, a concrete formwork adjoining at the top and extending upwards from the composite slab plane is applied to the intermediate space 41 for the bearing means 8 to be cast, whereby the bearing means 8, once finally cast, projects from the slab at the top. The internal bearing means 8 is usually not poured up to the subslab/screed 23, but, rather, an air gap is reserved for the cable routing—in particular, when it is designed as a continuous bearing means. In a maximum design, the internal bearing means 8 extends to the subslab 23 and consequently requires a detailed coordination of the cable routing. In any case, the raised portion exiting at the top of the internal bearing means 8 can be dimensioned according to the particular circumstances. If the story located above is not used, e.g., in an uppermost story, the bearing means 8 projecting at the top can also protrude beyond the subslab also as steps, or a subslab 23 can be dispensed with.

FIG. 9 shows an internal bearing means 8 coming out from the composite slab at the bottom. Due to its projection, the internal bearing means is optically perceptible and resembles a conventional bearing means. This type of bearing means design is particularly suitable if the slab structure does not allow a corresponding projection at the top. Such visible embodiments are primarily bearing means 8a that are primary and always indispensable in terms of statics, and the optical effect of which is therefore tolerable. For the production or assembly, a bearing member 49, as provided in FIG. 9 with a uniform hatching, is advantageously prefabricated as a separate component and is supported on the already-created column 18. The likewise prefabricated slab elements are then laid on the bearing members 49. For this purpose, the bearing member 49 forms a lower projection, which forms a step 47 on both sides, onto which the slab elements can be placed. In a last method step, the still-free region above the bearing member 49 between the concrete layers 4 of the slab modules is filled with concrete 48 in situ, as a result of which the upper end of the internal bearing means 8 is then monolithically connected thereto. The concrete layers 4 advantageously still reserve an edge region over the insulating layers 3, which edge region is then filled with concrete for the particularly solid connection of the modules to the internal bearing means 8. For clarification, the final casting of cast-in-place concrete 48 in FIG. 9 is differently hatched than the concrete of the prefabricated slab elements and of the prefabricated bearing member 49. It goes without saying that internal bearing means 8 projecting at the bottom can also be finally cast upwards by mounting corresponding temporary concrete formwork.

From an architectural point of view, the lower projection of the internal bearing means 8 can be perceived as optically dominant and accordingly be undesirable. A remedy is provided here by a capital construction as shown in cross-section in FIG. 10 a. The configuration shown here corresponds to that from FIG. 9, with the difference that the projection of the internal bearing means 8 does not run equally deep over its entire length; rather, its depth increases towards the column 18 and is thus integrally formed optically with the lateral arm of a capital. In FIG. 10 a, this capital arm runs in the direction of view from the sheet plane towards the column 18 behind the sheet plane. The inclination of the capital arm relative to the column 18 has been indicated with dashed lines oriented obliquely to one another.

FIG. 10 b shows a view through the section line A-A in FIG. 10 a, so that the capital can be seen as the upper end of the lower column 18 in a transverse view. The two capital arms of the internal bearing means 8 each run away from the column 18 and obviously extend only over a limited portion. The internally running portion of the bearing means 8 covered here can run continuously as far as the next support structure or beyond. The section line A-A for the view shown in the previous FIG. 10 a is also drawn in, and provides information about the viewing direction there. However, in FIG. 10 b, it is clear why this variant of the bearing means guide or embodiment of the projection of the internal bearing means 8 can also be advantageous. Instead of a continuously deeper slab portion, the slab height is impacted here only in an area around the column 18. The bearing means projection formed in this way is visually inconspicuous and nevertheless provides a decisive bending reinforcement. The internal bearing means 8 is prefabricated on the basis of a bearing member 49 with capital arms and is installed analogously to the configuration according to FIG. 9.

In the slab composite according to FIG. 10 b, a further internal bearing means 8 is visible transversely to the direction of extension of the capital. This is an internal bearing means 8 which is not visible from the outside, is produced with cast-in-place concrete 48, and, at the location of the prefabricated internal bearing means 8 that is integrally formed into the capital, is connected thereto with a suitable connection reinforcement 12. In the same way, a purely internally guided bearing means 8 runs on the opposite side of the arrangement shown here.

On the basis of the projecting variants of the internal bearing means 8, it is shown how the production method of the slab described at the outset can be adapted or modified, for example. The slab manufacturing method can be summarized as follows for both variants of the bearing means production—all on-site or partially prefabricated and partially on-site: the slab according to the invention is assembled from at least two slab modules, wherein the slab modules are created with their layer construction in each case, so that, from bottom to top, the wood layer 1 is produced first with the shear connectors 9 anchored therein with their lower ends. The insulating layer is then created. Preferably, it is formed with at least two insulating material layers 3a, 3b in that a comparatively denser insulating material is introduced for the lower layer 3a in order to introduce concentrated mass on and over the wood layer 1 in order to load it and thus make it vibration-resistant, while a comparatively less dense insulating material is introduced for the at least one upper layer 3b. The shear connectors 9 pass through the insulating layer 3. Finally, the concrete layer 4 is produced with its reinforcement 15, wherein the shear connectors 9 are anchored therein with their upper ends. After this, the slab modules are laid in the position predetermined for them on one or more supports. For this purpose, the two slab modules either
i. abut and thereby form an intermediate space 41. This is delimited at the bottom by a contact surface 35, excluded provisionally from material application, on the wood layer 1 of at least one of the slab modules and is delimited laterally by the insulation and concrete layers 3, 4 thereof.

Alternatively, the slab modules are supported on
ii. at least one prefabricated bearing member 49 which forms a lower projection, which forms a step 47 on both sides. A slab module on the bearing member 49 is then supported on each of these steps 47. An intermediate space 41 between the concrete layers 4 of the modules remains left above the bearing member 49.

A bearing means reinforcement 42 is inserted in the intermediate space 41 formed according to i. or ii. and connected to a reinforcement 15 of the adjacent concrete layers 4 of the slab modules. The intermediate space 41 is then filled with concrete 48, so that, with curing thereof, a bearing means 8 which is embedded within the composite slab and which is possibly projecting from the layer composite at the top and/or bottom is completely created. For the upper projection of an internal bearing means 8, an upwardly extending concrete formwork adjoining the corresponding intermediate space 41 is applied at the top, and the space 41 expanded as a result is filled with concrete 48. After the concrete 48 has cured, the concrete formwork is removed again, whereby a bearing means 8 projecting above is completely created.

The various embodiments prove that an internal bearing means 8 can be designed in a great variety of ways, sometimes through aesthetically designed projection shapes. Internal bearing means 8 projecting from the slab layer composite enable an even greater flexibility in the slab plan design, because the vertical supports due to their very large bending reinforcement do not have to be arranged as densely. On the other hand, it can also be desirable to let all internal bearing means 8 disappear in the slab. In a combined variant, for example, only the primary internal bearing means 8a can also project out, whereas the secondary bearing means 8b, which, except when a fire is involved, make a negligible static contribution anyway, are completely integrated into the slab. They then also have no optical effect as pure makeshift elements, whereas this is tolerated in the primary internal bearing means 8. The decision as to where which internal bearing means 8 are to project out of the slab can also be architecturally motivated and, statically, sufficiently implemented. Finally, each building has its own type, which is why one or the other embodiment variant is accordingly also better suited. In any case, the internal bearing means 8 can be selected individually and, if necessary, different embodiments can be combined with one another and can also be supplemented as desired with conventional bearing means that are not installed in the slab.

FIG. 11 shows a building 50 which is designed here as a high-rise building 50a with a total height of 80 m. Typically, the wood-concrete composite slab according to the invention is installed on each story and spans the same, with the exception of the building core 17. Fire and sound protection requirements are met in such a way here that the composite slab terminates on the interior side with the wood layer 1 and is made distinctive in terms of interior architecture. Thanks to the use of the slab according to the invention, a total of 28 stories can be achieved with the high-rise construction 50a in question.

### LEGEND

1 planar wood element, wood layer
2 concrete formwork, parting plane between concrete and wood support structure
3 insulating layer
3a layer of comparatively heavy insulating material
3b layer of comparatively light insulating material
4 concrete layer
5 wood beam
6 connecting elements between wood and concrete; wood screws
7 groove, shear channel
8 internal bearing means
8a primary internal bearing means 8
8b secondary internal bearing means 8
9 shear connectors, steel pipes
10 tensile reinforcement of the bearing means 8
11 compression reinforcement of the bearing means 8
12 connection reinforcement for the reinforcement 15 of the concrete layer 4 on the bearing means 8
13 stirrup reinforcement of the bearing means 8
14 bell butt joint for connection of the reinforcements 12 and 15
15 reinforcement of concrete layer 4, reinforcement rods
16 lateral surface of the bearing means 8
17 supporting building core
18 vertical support columns
19 façade walls of the building
20 steel beam profile
21a upper flange of the steel profile 20
21b lower flange of the steel profile 20
22 impact sound insulation and thermal insulation panel
23 subslab, screed
24 recess in the wooden panel
24a rear recess
24b hollow channel through the front intact material 27 of the wooden panel, which intact material 27 in this case is not intact solely due to the hollow channel 24b
24c front recess
25 common recess spanning across wooden panels
26 tensioning means
26a anchor; tensioning block, screw head, counter wedge
26b connection means for the anchor; threaded rod, tensioning arm
26c force transmission means; sleeve, lever, tensioning wedge
27 front intact material of the wooden panel, which is left intact except for any hollow channels 24b
28a rear end face of the front intact material 27 of the wooden panel
28b end face of the rear intact material 29 of the wooden panel
29 rear intact material of the wooden panel
30 recesses in the wood layer 1
31 formwork for a slab module
32 film for at least lateral framing of the insulating material
33 placeholder
34 sprinkler system
35 contact surface on the wood layer 1 for the internal bearing means 8 to be created later
36 layer separating film
37 auxiliary frame for the module formwork 31
38 stack magazine for the slab module
39 recesses in the concrete layer 4 or in the concrete layer 4 and in the insulating layer 3
40 common recess formed by the recesses 39
41 intermediate space for pouring an internal bearing means 8 with cast-in-place concrete
42 bearing means reinforcement
43 measuring rods
44 load-handling attachments, lifting belts
45 guides for the load-handling attachments 44
46 cavity under hollow slab
47 stage
48 cast-in-place concrete of the prefabricated internal bearing means 8
49 prefabricated bearing member
50 building
50a high-rise building

1.-95. (canceled)

96. A wood-concrete composite slab, the wood-concrete slab having a support structure comprising one component of concrete and one component of wood connected thereto in a shear-resistant manner, wherein the slab comprises a layer construction which, from bottom to top, includes, first, the wood component, namely a wood layer, extending in a planar manner and which can be subjected to a tensile load in the composite of the slab, followed by an insulating layer, and finally a concrete layer, wherein shear connectors are built into the composite slab, of which at least one shear connector simultaneously protrudes into the wood layer and into the concrete layer and in doing so passes through the insulating layer, and wherein the layer construction of the slab is interrupted by at least one bearing means, in that the bearing means traverses at least the concrete layer and the insulating layer and as a result extends downward at least as far as the wood layer, wherein the wood layer is not composed of strung-together wood beams, or the wood layer, in a bottommost section of the layer in relation to the layer thickness, is free of material-removing machining in the wood, and is thereby left intact.

97. A method for producing a wood-concrete composite slab according to claim 96 with at least two slab modules,
a. wherein the slab modules are each created with their layer construction so that, from bottom to top, first the wood layer with the shear connectors anchored therein with its lower ends is produced, then the insulating layer is formed, and finally the concrete layer is applied together with its reinforcement, so that the upper ends of the shear connectors are anchored in the concrete layer,
b. then the slab modules are laid in the position predetermined for them on one or more supports, wherein either
i. the two slab modules abut and thereby form an intermediate space which is delimited at the bottom by a contact surface, excluded provisionally from material application, on the wood layer of at least one of the slab modules and laterally by the insulating and concrete layers thereof,
or
ii. at least one of the supports is a prefabricated bearing member which forms a lower projection which forms a step on both sides, on which steps in each case a slab module is supported on the bearing member, wherein, between the concrete layers of the slab modules that are supported in this way, an intermediate space is left above the bearing member,
c. into the intermediate space, a bearing means reinforcement is inserted and is connected to the adjacent concrete reinforcement, and
d. the intermediate space is filled with concrete and, with curing thereof, the bearing means is completely created.

98. A wood-concrete composite slab, the wood-concrete slab having a support structure comprising a component of concrete and a component of wood connected thereto in a shear-resistant manner, wherein the slab comprises a layer construction which, from bottom to top, includes, first, a wood component, namely, a wood layer, extending in a planar manner which can be subjected to a tensile load in the composite of the slab, followed by an insulating layer, and finally a concrete layer, wherein shear connectors are installed in the composite slab, of which at least one shear connector simultaneously protrudes into the wood layer and the concrete layer and in doing so passes through the insulating layer, wherein the insulating layer comprises at least two insulating materials of different densities or specific weights, and the denser insulating material is arranged directly on this wood layer, which can be subject to tensile load in the slab composite, or rests directly thereon, which in both cases increases the inertia of the wood layer and is intended to act as a vibration damping means, wherein the wood layer is not composed of strung-together wood beams, or the wood layer, in a bottommost portion of the layer in relation to the layer thickness, is free of material-removing machining in the wood, and is thereby left intact, and the layer construction of the slab either extends without bearing means over the slab, or at least one bearing means traverses at least the concrete layer and the insulating layer and as a result extends downward at least as far as the wood layer.

99. A method for producing a wood-concrete composite slab according to claim 98 having at least two slab modules,
a. wherein the slab modules are each created with their layer construction, so that, from bottom to top, the wood layer is first produced with the shear connectors anchored therein with their lower ends,
b. the insulating layer is then formed with at least two insulating materials by first introducing the denser insulating material, which increases the inertia of the wood layer and is intended to act as a vibration damping means, and then the less dense insulating material is arranged or a cavity is left open for this purpose,
c. finally, the concrete layer is created with its reinforcement so that the shear connectors are anchored with their upper ends in the concrete layer, wherein, for the connection to the at least second slab module, its reinforcement protrudes from the recesses in the concrete layer, and
d. the completely created slab module is laid in the position predetermined for it on one or more supports and is connected to the at least second slab module by the reinforcements of the adjacent concrete layers being frictionally connected, and the recesses then being concreted.

100. A wood-concrete composite slab, the wood-concrete slab having a support structure of which comprises a component of concrete and a component of wood which is connected thereto in a shear-resistant manner, wherein the slab comprises a layer construction which, from bottom to top, includes, first, a wood component, namely, a wood layer, extending in a planar manner and which can be subjected to a tensile load in the composite of the slab, followed by either an insulating layer and finally a concrete layer, or, in the absence of the insulating layer, followed by a concrete layer, wherein the wood layer includes at least two abutting wooden panels which are reciprocally tensioned against one another, in that in each case one wooden panel presses vertically against the respective other wooden panel at a parting plane formed in the abutting connection, wherein, in each of the wooden panels that are tensioned against one another in this way leaving intact its underside, at least one recess is created by material removal in such a way that this at least one box-shaped space is formed in the wooden panel and forms with a recess of the wooden panel located on the remote side of the parting plane a passage taken out of the two wooden panels and spanning across them, wherein the wooden panels being mutually tensioned against each other, viewed from the parting plane, are each left intact in a region extending behind their one or rear box-shaped space in a direction perpendicular to and away from the parting plane, and there form, therefore, a rear intact material for other use, wherein the tensioning means is brought into the passage and at each end is anchored in at least one box-shaped space, so that, as a result of the tensioning of this tensioning means, the wooden panels are tensioned against one another, wherein the wood layer is not composed of strung-together wood beams, or the wood layer, in a bottommost section of the layer in relation to the layer thickness, is free of material-removing machining in the wood, and is thereby left intact, and wherein the layer construction of the slab either extends free of bearing means over the slab, or, if an insulating layer is present, at least one bearing means traverses at least the concrete layer and the insulating layer and as a result extends downward at least as far as the wood layer.

101. A method for producing a wood-concrete composite slab according to claim 100, wherein,
a. in each of the wooden panels to be tensioned, the at least one recess is created, by material removal, in such a way that it forms at least one box-shaped space,
b. the wooden panels are then laid in abutment, wherein their recesses form a recessed passage spanning across the two wooden panels, and
c. the tensioning means is introduced into the passage and is anchored in the at least one or rear box-shaped space at each end, and
d. wherein the tensioning means is tensioned from above.

102. A building comprising a wood-concrete composite slab, the wood-concrete slab having a support structure comprising one component of concrete and one component of wood connected thereto in a shear-resistant manner, wherein the slab comprises a layer construction which, from bottom to top, includes, first, the wood component, namely a wood layer, extending in a planar manner and which can be subjected to a tensile load in the composite of the slab, followed by an insulating layer, and finally a concrete layer, wherein shear connectors are built into the composite slab, of which at least one shear connector simultaneously protrudes into the wood layer and into the concrete layer and in doing so passes through the insulating layer, and wherein the layer construction of the slab is interrupted by at least one bearing means, in that the bearing means traverses at least the concrete layer and the insulating layer and as a result extends downward at least as far as the wood layer, wherein the wood layer is not composed of strung-together wood beams, or the wood layer, in a bottommost section of the layer in relation to the layer thickness, is free of material-removing machining in the wood, and is thereby left intact.

103. A building according to claim 102, wherein the building is designed as a high-rise building with a total height starting at 25 m.
